(19) United States
(12) Patent Application Publication
(10) Pub. No.: US 2022/0091894 A1
(43) Pub. Date: Mar. 24, 2022

(54) SYSTEM AND METHOD FOR DATA PROCESSING

(71) Applicant: WUHAN UNITED IMAGING HEALTHCARE CO., LTD., Wuhan (CN)

(72) Inventors: Chao XIA, Wuhan (CN); Xing MING, Wuhan (CN); Jing GAO, Wuhan (CN); Liangjie HE, Wuhan (CN); Xu ZHOU, Wuhan (CN)

(73) Assignee: WUHAN UNITED IMAGING HEALTHCARE CO., LTD., Wuhan (CN)

(21) Appl. No.: 17/448,546

(22) Filed: Sep. 23, 2021

(30) Foreign Application Priority Data
Sep. 23, 2020 (CN) 202011006550.6
Dec. 2, 2020 (CN) 202011386668.6

(51) Int. Cl. G06F 9/50; G06F 9/54; G06T 1/20; G06F 9/455

(52) U.S. Cl. CPC G06F 9/5038; G06F 9/5055; G06F 9/546; G06F 9/5072; G06F 2209/5021; G06F 9/45558; G06F 2009/45583; G06F 2009/4557; G06T 1/20

(57) ABSTRACT

The present disclosure directs to a system and method for allocating and scheduling resources for data processing. The method comprises setting a plurality of containers on a processing apparatus. Each of the plurality of containers may be allocated with a corresponding virtual graphic processing unit (VGPU) resource. The method further comprises identifying one or more target containers from the plurality of containers. For each of the one or more target containers, the method further comprises causing the target container to obtain a target task from a message queue that includes at least one task, and causing the target container to process the target task.

### CROSS-REFERENCE TO RELATED APPLICATIONS

This application claims priority of Chinese Patent Application No. 2020110065506, filed on Sep. 23, 2020, and Chinese Patent Application No. 2020113866686, filed on Dec. 2, 2020, the contents of each of which are hereby incorporated by reference.

### TECHNICAL FIELD

The present disclosure generally relates to data processing, and more particularly to resource allocation and scheduling for data processing.

### BACKGROUND

Currently, three-dimensional (3D) images generated in, e.g., magnetic resonance imaging (MRI), positron emission tomography (PET), computed tomography (CT), single-photon emission computed tomography (SPECT), etc., are widely used in clinical diagnosis and/or treatment. Such 3D images generally include a large amount of data, occupy a large volume of resources (e.g., graphics processing unit (GPU) resources), and need a great image rendering capacity. However, resources on terminal devices (e.g., a client terminal, a console) may be limited, and can hardly process such 3D images with a satisfactory performance. Thus, it is desirable to provide systems and methods for allocating and scheduling resources for data processing effectively and efficiently.

### SUMMARY

According to an aspect of the present disclosure, a method for allocating and scheduling resources for data processing is provided. The method may include setting a plurality of containers on a processing apparatus. Each of the plurality of containers may be allocated with a corresponding virtual graphic processing unit (VGPU) resource. The method may further include identifying one or more target containers from the plurality of containers. For each of the one or more target containers, the method may further include causing the target container to obtain a target task from a message queue that includes at least one task, and causing the target container to process the target task.

In some embodiments, the processing apparatus may include at least one cloud server cluster.

In some embodiments, the method may further include receiving a processing request from a terminal device, and the processing request may include at least one task. For each of the at least one task, the method may further include determining a requested volume of a VGPU resource corresponding to the task, adding the at least one task to the message queue, and marking each of the at least one task according to at least the requested volume of the VGPU resource.

In some embodiments, the causing the target container to obtain a target task from a message queue that includes at least one task may include identifying the target task from the message queue based at least in part on the requested volume of the VGPU resource corresponding to the target task.

In some embodiments, the identifying the target task from the message queue based at least in part on the requested volume of the VGPU resource corresponding to the target task may include determining whether a requested volume of the VGPU resource corresponding to a current task in the message queue matches a capacity of the target container, and in response to determining that the requested volume of the VGPU resource corresponding to the current task matches the capacity of the target container, designating the current task as the target task.

In some embodiments, the method may further include in response to determining that the requested volume of the VGPU resource corresponding to the current task does not match the capacity of the target container, putting the current task back into the message queue, and determining whether a requested volume of the VGPU resource corresponding to a subsequent task in the message queue matches the capacity of the target container.

In some embodiments, each of the at least one task may have a priority level, and the at least one task may be arranged in an order in the message queue according to the priority level of each of the at least one task.

In some embodiments, each of the plurality of containers may correspond to a VGPU resource.

In some embodiments, a capacity of a first container of the plurality of containers may be different from a capacity of a second container of the plurality of containers.

In some embodiments, the method may further include setting a renewed first container according to a mirrored first container if a first container collapses, and putting a task processed by the first container back into the message queue.

According to another aspect of the present disclosure, a method for allocating and scheduling resources for data processing is provided. The method may include identifying, from a plurality of edge nodes that are associated with a terminal device, a target edge node, transmitting at least one task to the target edge node for processing, and receiving a processing result of the at least one task from the target edge node.

In some embodiments, the identifying, from a plurality of edge nodes that are associated with a terminal device, a target edge node may include obtaining node information of the plurality of edge nodes, determining a communication distance between each of at least a portion of the plurality of edge nodes and the terminal device based on the node information, identifying a first edge node from the plurality of edge nodes based on the determined communication distances, and transmitting a first request regarding the target edge node to the first edge node.

In some embodiments, the method may further include receiving, from the first edge node, a first response indicating that the first edge node is capable of processing the at least one task, and designating the first edge node as the target edge node.

In some embodiments, the method may further include receiving, from a cloud server, a second response including an identification of a second edge node. The second edge node may be allocated by the cloud server in response to the second request indicating that the first edge node is incapable of processing the at least one task, and a first communication distance between the first edge node and the terminal device may be shorter than a second communication distance between the second edge node and the terminal device. The method may further include determining the target edge node based on the second response.

In some embodiments, the identifying, from a plurality of edge nodes that are associated with a terminal device, a target edge node may include transmitting a third request regarding the target edge node to a cloud server, and receiving, from the cloud server, a third response including an identification of a third edge node. The third edge node may be capable of processing the at least one task, and the third edge node corresponding to a shortest communication distance among communication distances between edge nodes may be allocated by the cloud server and the terminal device. The method may further include determining the target edge node based on the third response.

In some embodiments, the target edge node may include one or more target containers, and the one or more target containers may correspond to virtual graphic processing unit (VGPU) resources.

In some embodiments, the method may further include causing the one or more target containers to obtain and process the at least one task.

In some embodiments, the method may further include transmitting the at least one task to a cloud server for processing if there is no target edge node, and receiving a processing result of the at least one task from the cloud server.

In some embodiments, the cloud server may include one or more target containers, and the one or more target containers may correspond to VGPU resources.

According to a further aspect of the present disclosure, a system for allocating and scheduling resources for data processing is provided. The system may include at least one storage device including a set of instructions, and at least one processor configured to communicate with the at least one storage device. When executing the set of instructions, the at least one processor may be configured to direct the system to perform the following operations. The at least one processor may be configured to direct the system to set a plurality of containers on a processing apparatus. Each of the plurality of containers may be allocated with a corresponding virtual graphic processing unit (VGPU) resource. The at least one processor may be also configured to direct the system to identify one or more target containers from the plurality of containers. For each of the one or more target containers, the at least one processor may be further configured to direct the system to cause the target container to obtain a target task from a message queue that includes at least one task, and cause the target container to process the target task.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating exemplary hardware and/or software components of an exemplary terminal according to some embodiments of the present disclosure;

FIG. 4 is a block diagram illustrating an exemplary processing apparatus according to some embodiments of the present disclosure;

FIG. 5 a schematic diagram illustrating an exemplary processing apparatus according to some embodiments of the present disclosure;

FIG. 6 is a flowchart illustrating an exemplary process for setting and causing one or more target containers to process at least one target task according to some embodiments of the present disclosure;

FIG. 7 is a flowchart illustrating an exemplary process for adding at least one task to a message queue according to some embodiments of the present disclosure;

FIG. 8 is a flowchart illustrating an exemplary process for causing a target container to obtain a target task from a message queue according to some embodiments of the present disclosure;

FIG. 9 is a flowchart illustrating an exemplary process for recovering a first container from a collapse according to some embodiments of the present disclosure;

FIG. 10 is a schematic diagram illustrating an exemplary processing apparatus according to some embodiments of the present disclosure;

FIG. 11 is a flowchart illustrating an exemplary process for scheduling resources of a processing apparatus according to some embodiments of the present disclosure;

FIG. 12 is a flowchart illustrating an exemplary process for identifying a target edge node from a plurality of edge nodes according to some embodiments of the present disclosure;

FIG. 13 is a flowchart illustrating an exemplary process for identifying a target edge node from a plurality of edge nodes according to some embodiments of the present disclosure;

FIG. 14 is a flowchart illustrating an exemplary process for identifying a target edge node from a plurality of edge nodes according to some embodiments of the present disclosure;

FIG. 15 is a flowchart illustrating an exemplary process for identifying a target edge node according to some embodiments of the present disclosure;

FIG. 16 is a flowchart illustrating an exemplary process for scheduling resources of the processing apparatus for processing at least one task from a terminal device according to some embodiments of the present disclosure;

FIG. 17 is a flowchart illustrating an exemplary process for scheduling resources of the processing apparatus to process at least one task from a terminal device according to some embodiments of the present disclosure; and

FIG. 18 is a flowchart illustrating an exemplary process for scheduling resources of the processing apparatus to process at least one task from a terminal device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by other expression if they achieve the same purpose.

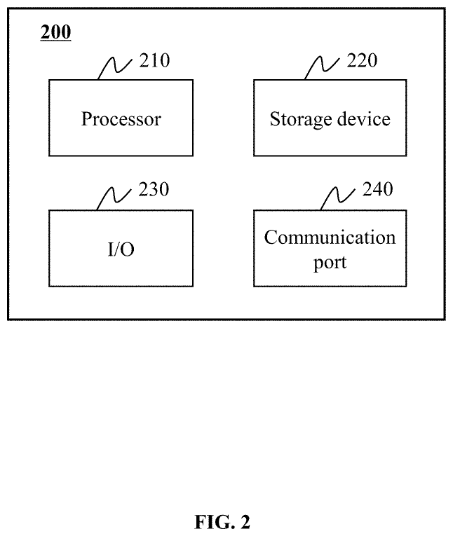

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The flowcharts used in the present disclosure illustrate operations that systems implement according to some embodiments of the present disclosure. It is to be expressly understood the operations of the flowcharts may be implemented not in order. Conversely, the operations may be implemented in an inverted order, or simultaneously. Moreover, one or more other operations may be added to the flowcharts. One or more operations may be removed from the flowcharts.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Provided herein are systems and methods for non-invasive imaging, such as for disease diagnosis, treatment, and/or research purposes. In some embodiments, the imaging system may include a single modality system and/or a multi-modality system. The term “modality” used herein broadly refers to an imaging or treatment method or technology that gathers, generates, processes, and/or analyzes imaging information of a subject or treatments the subject. The single modality system may include a computed tomography (CT) system, a magnetic resonance imaging (MRI) system, an ultrasound imaging system, an X-ray imaging system, an ultrasonography system, a positron emission tomography (PET) system, an optical coherence tomography (OCT) imaging system, an ultrasound (US) imaging system, an intravascular ultrasound (IVUS) imaging system, a near-infrared spectroscopy (NIRS) imaging system, or the like, or any combination thereof. The multi-modality system may include an X-ray imaging-magnetic resonance imaging (X-ray-MRI) system, a positron emission tomography-X-ray imaging (PET-X-ray) system, a single-photon emission computed tomography-magnetic resonance imaging (SPECT-MRI) system, a positron emission tomography-computed tomography (PET-CT) system, a C-arm system, a positron emission tomography-magnetic resonance imaging (PET-MR) system, a digital subtraction angiography-magnetic resonance imaging (DSA-MRI) system, or the like, or any combination thereof.

In the present disclosure, the term “image” refers to a two-dimensional (2D) image, a three-dimensional (3D) image, or a four-dimensional (4D) image. In some embodiments, the term “image” refers to an image of a region (e.g., a region of interest (ROI)) of a subject. As described above, the image may be a CT image, a PET image, an MR image, a fluoroscopy image, an ultrasound image, an Electronic Portal Imaging Device (EPID) image, etc.

As used herein, a representation of a subject (e.g., a patient, or a portion thereof) in an image may be referred to as the subject for brevity. For instance, a representation of an organ or tissue (e.g., the heart, the liver, a lung, etc., of a patient) in an image may be referred to as the organ or tissue for brevity. An image including a representation of a subject may be referred to as an image of the subject or an image including the subject for brevity. As used herein, an operation on a representation of a subject in an image may be referred to as an operation on the subject for brevity. For instance, a segmentation of a portion of an image including a representation of an organ or tissue (e.g., the heart, the liver, a lung, etc., of a patient) from the image may be referred to as a segmentation of the organ or tissue for brevity.

A system for non-invasive imaging (also referred to as imaging system), such as for disease diagnosis, treatment, and/or research purposes, is provided in the present disclosure merely for illustration and are not intended to be limiting. In some embodiments, the system may be a system for image processing, data processing, or the like, or a combination thereof. For instance, the system may be an image processing system for image extraction, image segmentation, image enhancement, and/or image rendering.

In an aspect, the present disclosure is directed to systems and methods for allocating virtual graphic processing unit (VGPU) resources for data processing. A plurality of containers may be set on a processing apparatus (e.g., one or more cloud servers, edge nodes thereof, etc.). Each of the plurality of containers may be allocated with a corresponding VGPU resource. One or more target containers may be identified from the plurality of containers. For each of the one or more target containers, the target container may be caused to retrieve a target task (e.g., a task that matches the capacity of the target container) from a message queue that includes at least one task (e.g., a plurality of image processing tasks), and process the target task. The target containers occupying specific volumes of the VGPU resource may obtain and process the at least one task in a message queue, thus enhancing a utilization rate of the VGPU resources and improving the efficiency of processing the at least one task.

In another aspect, the present disclosure is directed to systems and methods for scheduling resources of cloud computing and edge computing for data processing. A target edge node (e.g., an edge node that is suitable for data processing and corresponds to a shortest communication distance to a terminal device) may be identified from a plurality of edge nodes that are associated with the terminal device. At least one task may be transmitted from the terminal device to the target edge node for processing. Then a processing result of the at least one task may be received from the target edge node. In the case that resources (e.g., a GPU resource, a processing resource, etc.) of the terminal device are insufficient, the target edge node that corresponds to the shortest communication distance may save resources of the terminal device and provide a satisfactory real-time performance on data processing.

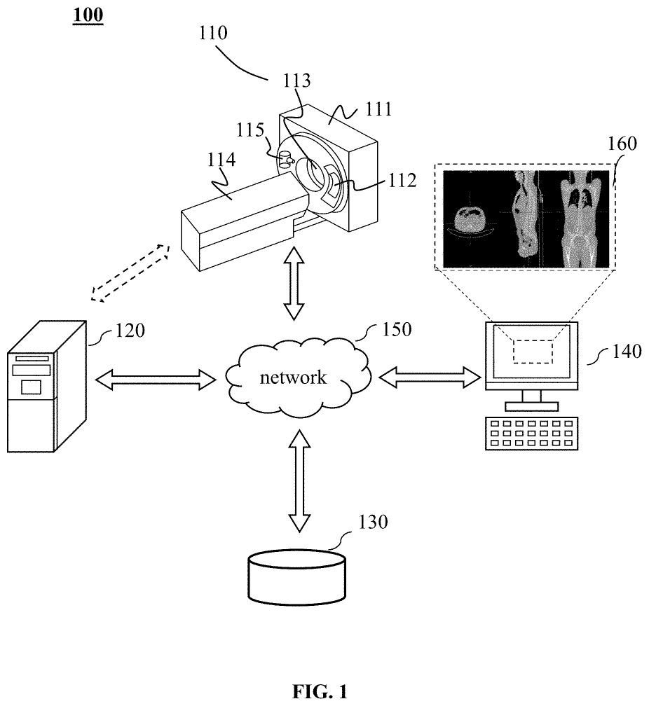

FIG. 1 is a schematic diagram illustrating an exemplary imaging system according to some embodiments of the present disclosure. As illustrated in FIG. 1, the imaging system 100 may include a scanner 110, a processing apparatus 120, a storage device 130, a terminal device 140, and a network 150. In some embodiments, two or more components of the imaging system 100 may be connected to and/or communicate with each other via a wireless connection, a wired connection, or a combination thereof. The connection among the components of the imaging system 100 may be variable. Merely by way of example, the scanner 110 may be connected to the processing apparatus 120 through the network 150 or directly. As another example, the storage device 130 may be connected to the processing apparatus 120 through the network 150 or directly.

The scanner 110 may be configured to scan a subject or a portion thereof that is located within its detection region and generate scanning data/signals relating to the (portion of) subject.

In some embodiments, the scanner 110 may include a single modality device. For example, the scanner 110 may include a CT scanner, a PET scanner, a SPECT scanner, an MR scanner, an ultrasonic scanner, an ECT scanner, or the like, or a combination thereof. In some embodiment, the scanner 110 may be a multi-modality device. For example, the scanner 110 may include a PET-CT scanner, a PET-MR scanner, or the like, or a combination thereof. The following descriptions are provided, unless otherwise stated expressly, with reference to a CT scanner for illustration purposes and not intended to be limiting.

As illustrated, the CT scanner may include a gantry 111, a detector 112, a detecting region 113, a table 114, and a radiation source 115. The gantry 111 may support the detector 112 and the radiation source 115. The subject may be placed on the table 114 for scanning. The radiation source 115 may emit x-rays. The x-rays may be emitted from a focal spot using a high-intensity magnetic field to form an x-ray beam. The x-ray beam may travel toward the subject. The detector 112 may detect x-ray photons from the detecting region 113. In some embodiments, the detector 112 may include one or more detector units. The detector unit(s) may be and/or include single-row detector elements and/or multi-row detector elements.

The processing apparatus 120 may process data and/or information. The data and/or information may be obtained from the scanner 110 or retrieved from the storage device 130, the terminal device 140, and/or an external device (external to the imaging system 100) via the network 150. For example, the processing apparatus 120 may process the data and/or information obtained from the scanner 110, and reconstruct a CT image based on the processed data and/or information. In some embodiments, the processing apparatus 120 may be a single server or a server group. The server group may be centralized or distributed. In some embodiments, the processing apparatus 120 may be local or remote. For example, the processing apparatus 120 may access information and/or data stored in the scanner 110, the terminal device 140, and/or the storage device 130 via the network 150. As another example, the processing apparatus 120 may be directly connected to the scanner 110, the terminal device 140, and/or the storage device 130 to access stored information and/or data. In some embodiments, the processing apparatus 120 may be implemented by a computing device 200 having one or more components as illustrated in FIG. 2. In some embodiments, the processing apparatus 120 may be implemented on one or more cloud servers and/or edge nodes. Merely by way of example, a cloud server may include a private cloud, a public cloud, a hybrid cloud, a community cloud, a distributed cloud, an inter-cloud, a multi-cloud, or the like, or any combination thereof. An edge node may be implemented by a server, a computer, etc.

The storage device 130 may store data, instructions, and/or any other information. In some embodiments, the storage device 130 may store data obtained from the scanner 110, the terminal device 140, and/or the processing apparatus 120. In some embodiments, the storage device 130 may store data and/or instructions that the processing apparatus 120 may execute or use to perform exemplary methods described in the present disclosure. In some embodiments, the storage device 130 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components (e.g., the processing apparatus 120, the terminal device 140) of the imaging system 100. One or more components of the imaging system 100 may access the data or instructions stored in the storage device 130 via the network 150. In some embodiments, the storage device 130 may be directly connected to or communicate with one or more other components (e.g., the processing apparatus 120, the terminal device 140) of the imaging system 100. In some embodiments, the storage device 130 may be part of the processing apparatus 120.

The terminal device 140 may input/output signals, data, information, etc. In some embodiments, the terminal device 140 may enable a user interaction with the processing apparatus 120. For example, the terminal device 140 may display an image of the subject on a screen 160. As another example, the terminal device 140 may obtain a user's input information through an input device (e.g., a keyboard, a touch screen, a brain wave monitoring device), and transmit the input information to the processing apparatus 120 for further processing. The terminal device 140 may be a mobile device, a tablet computer, a laptop computer, a desktop computer, or the like, or any combination thereof. In some embodiments, the mobile device may include a home device, a wearable device, a virtual reality device, an augmented reality device, or the like, or any combination thereof. The home device may include a lighting device, a control device of an intelligent electrical apparatus, a monitoring device, a television, a video camera, an interphone, or the like, or any combination thereof. The wearable device may include a bracelet, a footgear, eyeglasses, a helmet, a watch, clothing, a backpack, an accessory, or the like, or any combination thereof. The virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal device 140 may be part of the processing apparatus 120 or a peripheral device of the processing apparatus 120 (e.g., a console connected to and/or communicating with the processing apparatus 120).

The network 150 may include any suitable network that can facilitate the exchange of information and/or data for the imaging system 100. In some embodiments, one or more components (e.g., the scanner 110, the terminal device 140, the processing apparatus 120, the storage device 130) of the imaging system 100 may communicate information and/or data with one or more other components of the imaging system 100 via the network 150. The network 150 may be and/or include a public network (e.g., the Internet), a private network (e.g., a local area network (LAN), a wide area network (WAN))), a wired network (e.g., an Ethernet network), a wireless network (e.g., an 802.11 network, a Wi-Fi network), a cellular network (e.g., a Long Term Evolution (LTE) network, 4G network, 5G network), a frame relay network, a virtual private network (VPN), a satellite network, a telephone network, routers, hubs, switches, server computers, and/or any combination thereof. Merely by way of example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the imaging system 100 may be connected to the network 150 to exchange data and/or information.

It should be noted that the above description regarding the imaging system 100 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the imaging system 100 may include one or more additional components and/or one or more components of the imaging system 100 described above may be omitted. In some embodiments, a component of the imaging system 100 may be implemented on two or more sub-components. Two or more components of the imaging system 100 may be integrated into a single component.

FIG. 2 is a schematic diagram illustrating exemplary hardware and/or software components of an exemplary computing device according to some embodiments of the present disclosure. The computing device 200 may be configured to implement any component of the imaging system 100. For example, the scanner 110, the processing apparatus 120, the storage device 130, and/or the terminal device 140 may be implemented on the computing device 200. Although only one such computing device is shown for convenience, the computer functions relating to the imaging system 100 as described herein may be implemented in a distributed fashion on a number of similar platforms, to distribute the processing load. As illustrated in FIG. 2, the computing device 200 may include a processor 210, a storage device 220, an input/output (I/O) 230, and a communication port 240.

The processor 210 may execute computer instructions (e.g., program codes) and perform functions of the processing apparatus 120 in accordance with techniques described herein. The computer instructions may include, for example, routines, programs, objects, components, signals, data structures, procedures, modules, and functions, which perform particular functions described herein. In some embodiments, the processor 210 may perform instructions obtained from the terminal device 140 and/or the storage device 130. In some embodiments, the processor 210 may include one or more hardware processors, such as a microcontroller, a microprocessor, a reduced instruction set computer (RISC), an application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field-programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage device 220 may store data/information obtained from the scanner 110, the terminal device 140, the storage device 130, or any other component of the imaging system 100. In some embodiments, the storage device 220 may include a mass storage device, a removable storage device, a volatile read-and-write memory, a read-only memory (ROM), or the like, or any combination thereof. In some embodiments, the storage device 220 may store one or more programs and/or instructions to perform exemplary methods described in the present disclosure.

The I/O 230 may input or output signals, data, and/or information. In some embodiments, the I/O 230 may enable user interaction with the processing apparatus 120. In some embodiments, the I/O 230 may include an input device and an output device. Exemplary input devices may include a keyboard, a mouse, a touch screen, a microphone, a camera capturing gestures, or the like, or a combination thereof. Exemplary output devices may include a display device, a loudspeaker, a printer, a projector, a 3D hologram, a light, a warning light, or the like, or a combination thereof. Exemplary display devices may include a liquid crystal display (LCD), a light-emitting diode (LED)-based display, a flat panel display, a curved screen, a television device, a cathode ray tube (CRT), or the like, or a combination thereof.

The communication port 240 may be connected with a network (e.g., the network 150) to facilitate data communications. The communication port 240 may establish connections between the processing apparatus 120 and the scanner 110, the terminal device 140, or the storage device 130. The connection may be a wired connection, a wireless connection, or a combination of both that enables data transmission and reception. The wired connection may include an electrical cable, an optical cable, a telephone wire, or the like, or any combination thereof. The wireless connection may include a Bluetooth network, a Wi-Fi network, a WiMax network, a WLAN, a ZigBee network, a mobile network (e.g., 3G, 4G, 5G), or the like, or any combination thereof. In some embodiments, the communication port 240 may be a standardized communication port, such as RS232, RS485, etc. In some embodiments, the communication port 240 may be a specially designed communication port. For example, the communication port 240 may be designed in accordance with the digital imaging and communications in medicine (DICOM) protocol.

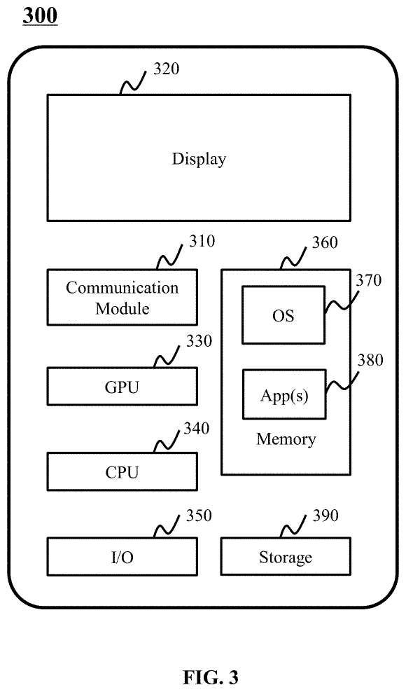

FIG. 3 is a schematic diagram illustrating exemplary hardware and/or software components of an exemplary mobile device according to some embodiments of the present disclosure. In some embodiments, the processing apparatus 120 or the terminal device 140 may be implemented on the mobile device 300. As illustrated in FIG. 3, the mobile device 300 may include a communication module 310, a display 320, a graphics processing unit (GPU) 330, a central processing unit (CPU) 340, an I/O 350, a memory 360, and storage 390. The CPU 340 may include interface circuits and processing circuits similar to the processor 210. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to imaging from the imaging system on the mobile device 300. User interactions with the information stream may be achieved via the I/O devices 350 and provided to the processing apparatus 120 and/or other components of the imaging system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

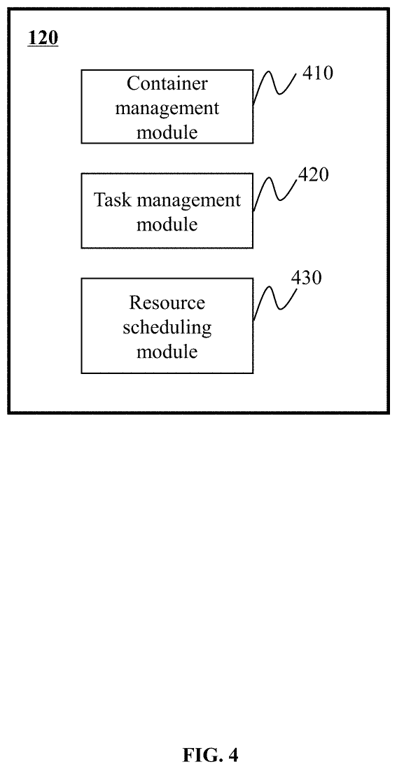

FIG. 4 is a block diagram illustrating an exemplary processing apparatus according to some embodiments of the present disclosure. As illustrated in FIG. 4, the processing apparatus 120 may include a container management module 410, a task management module 420, and a resource scheduling module 430.

The container manager module 410 may be configured to set a plurality of containers on a processing apparatus and manage the plurality of containers or a portion thereof. A virtual graphic processing unit (VGPU) resource for data processing, image processing, data storage, etc., may be allocated to each of the plurality of containers. Each of the plurality of containers may occupy a corresponding VGPU resource. In some embodiments, the container management module 410 may identify one or more target containers (e.g., containers in idle states) from the plurality of containers. The container management module 410 may cause each of the one or more target containers to retrieve a target task from a message queue that includes at least one task and process the retrieved target task.

The task management module 420 may manage at least one task. In some embodiments, the task management module 420 may determine a requested volume of a VGPU resource corresponding to each of the at least one task. The requested volume of the VGPU resource corresponding to each of the at least one task may be determined based on, for example, a volume of data relating to each of the at least one task. The task management module 420 may add the at least one task to a message queue, and mark each of the at least one task according to at least the requested volume of the VGPU resource. In some embodiments, each of the at least one task may have a priority level. The task management module 420 may add the at least one task the message queue in an order according to the priority level of each of the at least one task.

The resource scheduling module 430 may allocate and schedule resources for processing at least one task. In some embodiments, the resource scheduling module 430 may identify, from a plurality of edge nodes that are associated with a terminal device, a target edge node. For example, an edge node that corresponds to a shortest communication distance to a terminal device among communication distances between the terminal device and one or more edge nodes that are capable of processing the at least one task may be determined as the target edge node. The resource scheduling module 430 may transmit at least one task to the target edge node for processing. Then the resource scheduling module 430 may receive a processing result of the at least one task from the target edge node.

Two or more of the modules in the processing apparatus 120 may be combined into a single module, and any one of the modules may be divided into two or more units. For example, the above-mentioned modules may be integrated into a console (not shown). Via the console, a user may set parameters for scanning a subject, controlling imaging processes, adjusting reconstruction protocols for reconstruction of an image, viewing images, etc. As another example, the processing apparatus 120 may include a storage module (not shown) configured to store information and/or data (e.g., ultrasound signals, images) associated with the above-mentioned modules.

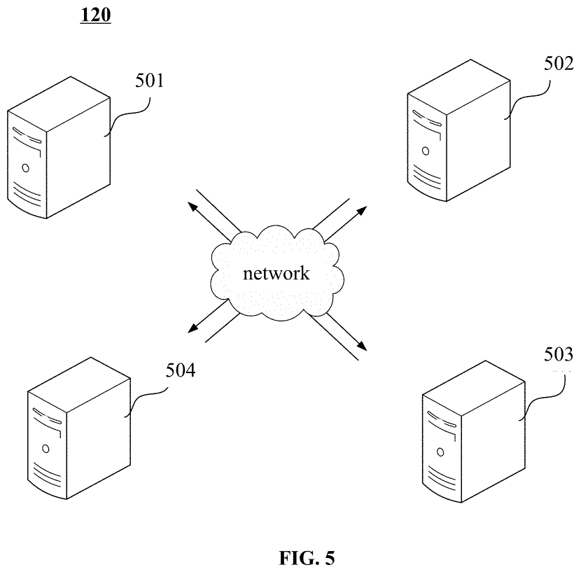

FIG. 5 is a schematic diagram illustrating an exemplary processing apparatus according to some embodiments of the present disclosure.

As shown in FIG. 5, the processing apparatus 120 may include a cloud server cluster. The cloud server cluster refers to a cluster of a plurality of cloud servers. The plurality of cloud servers may include, for example, a private cloud, a public cloud, a hybrid cloud, a community cloud, a distributed cloud, an inter-cloud, a multi-cloud, or the like, or any combination thereof. Merely by way of example, the plurality of cloud servers may include cloud servers 501-504. In some embodiments, the cloud servers 501-504 may be cloud servers of a same type, for example, a public cloud. In some embodiments, at least two of the cloud servers 501-504 may be of cloud servers of different types. For instance, the cloud server 501 may be a public cloud, and the cloud servers 502-504 may be distributed clouds.

The cloud servers 501-504 may communicate with each other via a network. The network may be and/or include any suitable network that can facilitate the exchange of information and/or data for the cloud servers 501-504. The network may be and/or include a public network (e.g., the Internet), a private network (e.g., a local area network (LAN), a wide area network (WAN))), a wired network (e.g., an Ethernet network), a wireless network (e.g., an 802.11 network, a Wi-Fi network), a cellular network (e.g., a Long Term Evolution (LTE) network, 4G network, 5G network), a virtual private network (VPN), etc.

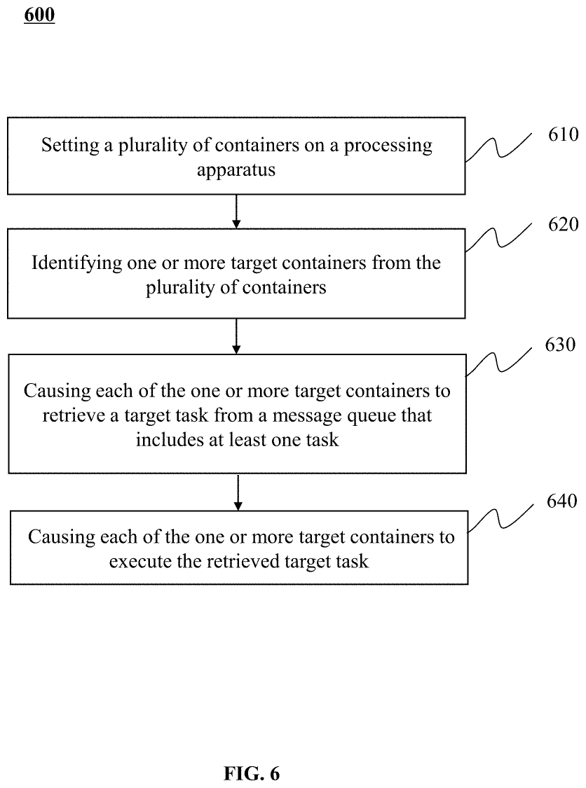

FIG. 6 is a flowchart illustrating an exemplary process for setting and causing one or more target containers to process at least one target task according to some embodiments of the present disclosure. In some embodiments, the process 600 may be executed by the imaging system 100. For example, the process 600 may be implemented as a set of instructions (e.g., an application) stored in a storage device (e.g., the storage device 130). The modules described in FIG. 4 may execute the set of instructions and may accordingly be directed to perform the process 600. The operations of the illustrated process presented below are intended to be illustrative. In some embodiments, the process 600 may be accomplished with one or more additional operations not described and/or without one or more of the operations discussed. Additionally, the order of the operations of process 600 illustrated in FIG. 6 and described below is not intended to be limiting.

In 610, the container management module 410 may set a plurality of containers on a processing apparatus.

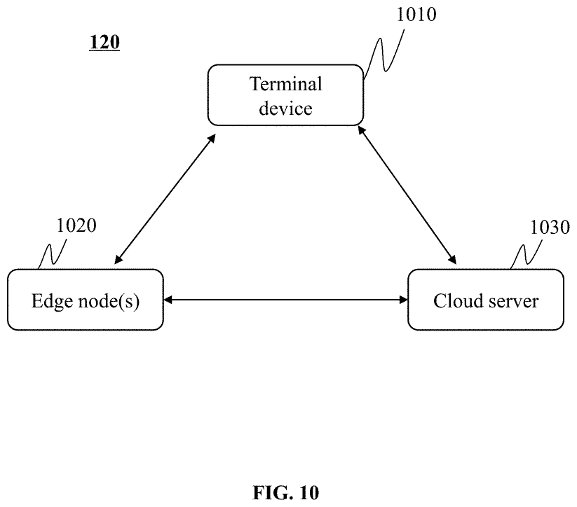

In some embodiments, the processing apparatus (e.g., the processing apparatus 120) may be implemented as a cloud server cluster. The cloud server cluster may include a plurality of cloud servers. The container management module 410 may set a plurality of containers on the cloud server cluster. In some embodiments, one or more containers may be set on at least one cloud server of the cloud server cluster. It should be noted that the processing apparatus may also be implemented as other suitable devices (e.g., the one or more edge nodes 1020 as described in FIGS. 10-18)

Each of the plurality of containers may be associated with an operation or service. Exemplary operations or services may include data calculation, image reconstruction, image extraction (e.g., artery extraction, nodule extraction, etc.), image segmentation, image rendering, or the like, or a combination thereof. A container may provide an operating environment (including, e.g., hardware, software) for the operation or service. Merely for illustration, the container may be an image processing container. The image processing container may include one or more image processing algorithms and/or image processing models. The image processing container may provide an operating environment for processing a task related to image processing using at least one of the one or more image processing algorithms and/or image processing models. During this process, the image processing container may execute instructions of a specific format, such as OpenCL, C, C++, Python, etc. In some embodiments, in addition to the one or more image processing algorithms and/or image processing models, the image processing container may also include data or information associated with the image processing operation or service, class libraries, binary files, configuration files, or the like, in the image processing operation or service.

A count of the plurality of containers may be set by a user, according to default settings of the imaging system 100, etc. In some embodiments, the container management module 410 may adjust the count of the containers set on the processing apparatus dynamically. For example, the container management module 410 may determine the count of the containers set on the processing apparatus based on at least one task to be processed by the plurality of containers (e.g., a count of the at least one task).

A virtual graphic processing unit (VGPU) resource for data processing, image processing, data storage, etc., may be allocated to each of the plurality of containers. Each of the plurality of containers may occupy a corresponding VGPU resource. The VGPU resource may be provided through, for example, an independent graphic processing card, NVIDIA VGPU technology, etc. In some embodiments, a VGPU resource corresponding to a container may have a specific volume, such as 1 gigabyte (GB), 2 GB, 4 GB, 8 GB, etc.

In some embodiments, the plurality of containers may include at least a first container and a second container. A first volume of the VGPU resource allocated to the first container may be the same as or different from a second volume of the VGPU resource allocated to the second container. Merely for illustration, the container management module 410 may set three containers on the cloud server cluster. The three containers may include a first container set on the cloud server 501, and a second container and a third container set on the cloud server 502. The first container may correspond to a VGPU resource of a volume of 4 GB, the second container may correspond to a VGPU resource of a volume of 2 GB, and the third container may correspond to a VGPU resource of a volume of 2 GB.

In 620, the container management module 410 may identify one or more target containers from the plurality of containers.

In some embodiments, the container management module 410 may identify, in real-time or intermittently (e.g., periodically or aperiodically), whether each of the plurality of containers is in an idle state. The idle state refers to a state in which a container is not processing a task. If a container is in the idle state, the container may be determined as a target container.

For instance, the container management module 410 may check the three containers including the first container set on the cloud server 501, the second container, and the third container set on the cloud server 502 is in the idle state sequentially and determine if any one of the three containers is in the idle state. If the first container is in the idle state, and the second container and the third container are not in the idle states (e.g., the second container and the third container are in working states), the first container may be designated as a target container, and the second containers and the third container may not be designated as target containers.

In some embodiments, if two or more containers are in the idle state, the container management module 410 may select at least one container from the two or more containers according to a preset rule. The preset rule may relate to at least one of the respective sequence numbers of the two or more containers, a volume of the VGPU resource allocated to each of the two or more containers, an idle duration of each of the two or more containers, etc. As used herein, the idle duration refers to a time period that a container remains in the idle state. The at least one selected container may be designated as the one or more target containers.

Merely for illustration, both the first container and the second container may be in the idle states, the idle duration of the second container may be longer than that of the first container, and the third container may be in the working state. The first container may correspond to a VGPU resource of a volume of 4 GB, and the second container may correspond to a VGPU resource of a volume of 2 GB. In some embodiments, the container management module 410 may select, according to an order (e.g., ascending order, descending order) of the sequence numbers of the two or more containers in the idle state (e.g., the first container and the second container), the first container from the two or more containers and designate the first container as the target container. In some embodiments, the container management module 410 may select, according to an order (e.g., ascending order, descending order) of the volumes of the VGPU resources allocated to the two or more containers, the second container (corresponding to a volume of the VGPU resource of 2 GB) from the two or more containers and determine the second container as the target container. In some embodiments, the container management module 410 may select, according to an order (e.g., ascending order, descending order) of the idle durations of the two or more containers, the second container from the two or more containers and designate the second container as the target container.

In 630, the container management module 410 may cause each of the one or more target containers to retrieve a target task from a message queue that includes at least one task.

The message queue refers to a queue of at least one task from one or more request messages. In some embodiments, the one or more request messages may be generated by a terminal device (e.g., a client terminal, a console, the terminal device 140, etc.) for requesting the plurality of containers to process the at least one task when resources (e.g., a GPU resource) of the terminal device are insufficient for processing the at least one task. In some embodiments, each of the at least one request message may include one or more tasks. The message queue may be in the form of, e.g., a Kafka message queue, a Redis message queue, a Rabbit MQ message queue, etc. By arranging the at least one task in the message queue, a problem of a high concurrency of the at least one task (e.g., two or more of the at least one task are put into a same task container) may be solved, and the efficiency for processing the at least one task may be improved. In some embodiments, each of the at least one task may have a priority level. The priority level may be determined by a user, according to default settings of the imaging system 100, etc. The at least one task may be arranged in an order in the message queue according to the priority level of each of the at least one task.

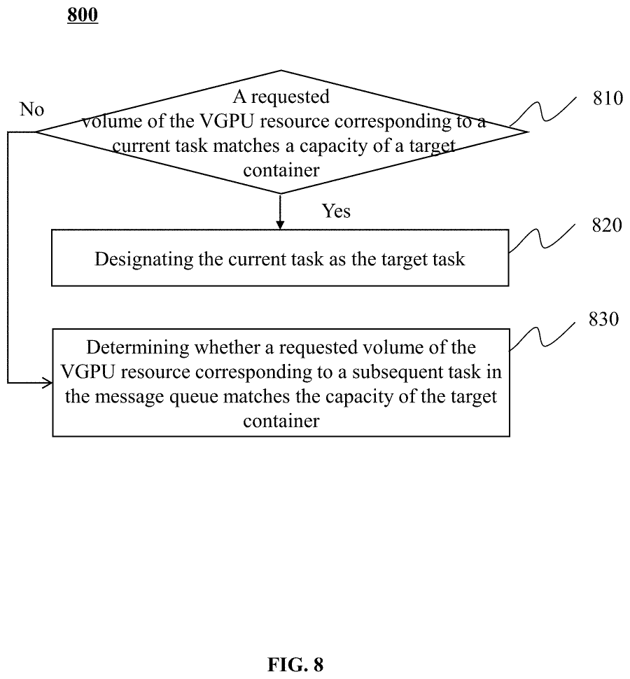

After the one or more target containers are determined, the container management module 410 may cause each of the one or more target containers to retrieve a target task from the message queue. In some embodiments, for each of the one or more target containers, the container management module 410 may identify a target task from the at least one task in the message queue based at least in part on a requested volume of the VGPU resource corresponding to each of the at least one task. A requested volume of the VGPU resource corresponding to a task refers to a volume of the VGPU resource needed for processing the task. If a requested volume of the VGPU resource corresponding to a current task matches a capacity of a target container (e.g., the requested volume of the VGPU resource being smaller than or equal to a volume of the VGPU resource allocated to the target container), the current task may be designated as the target task corresponding to the target container. Details regarding the identification of the target task may be found elsewhere in the present disclosure. See, for example, FIG. 8 and the descriptions thereof.

In some embodiments, the volume of the VGPU resource allocated to each of the plurality of containers may be fixed. In this case, after the VGPU resource is allocated for each of the plurality of containers, the one or more target containers may be identified from the plurality of containers and caused to obtain their respective target tasks. In some embodiments, the volume of the VGPU resource allocated to at least one of the plurality of containers may be variable (e.g., dynamically adjustable according to the corresponding target task).

In 640, the container management module 410 may cause each of one or more target containers to process the retrieved target task.

For each of the one or more target containers, after the target container retrieves the target task, the target container may process the target task.

According to the embodiments set forth above in the process 600, the plurality of containers may be set on the processing apparatus, and each of the plurality of containers may be allocated with a VGPU resource. One or more containers in the idle state may be identified and designated as the target containers. Each of the one or more target containers may retrieve and process a target task from a message queue that includes at least one task. The target containers occupying specific volumes of the VGPU resource(s) may retrieve and process the at least one task in a message queue, thus enhancing a utilization rate of the VGPU resources and improving the efficiency of processing the at least one task.

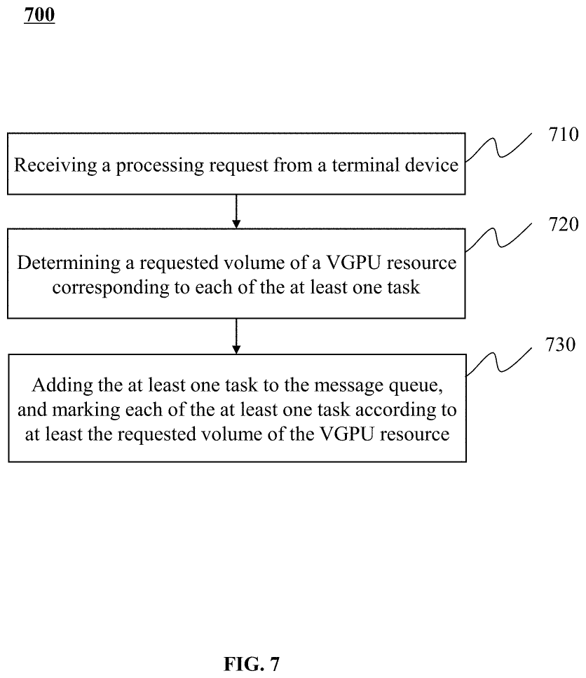

FIG. 7 is a flowchart illustrating an exemplary process for adding at least one task to a message queue according to some embodiments of the present disclosure. In some embodiments, the process 700 may be executed by the imaging system 100. For example, the process 700 may be implemented as a set of instructions (e.g., an application) stored in a storage device (e.g., the storage device 130). The modules described in FIG. 4 may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting.

In 710, the task management module 420 may receive a processing request from a terminal device.

When the terminal device has a request for processing the at least one task, the terminal device may send a processing request (e.g., in the form of the request message) to the task management module 420. The processing request may include the at least one task. In some embodiments, the at least one task may relate to image processing regarding one or more images. The at least one task may include, for example, image segmentation, image extraction, image reconstruction, image rendering, etc.

For example, the terminal device 140 may have a request for blood vessel extraction on two medical images. The terminal device 140 may send a processing request to the task management module 420. The processing request may include two tasks for blood vessel extraction. Each of the two tasks may correspond to a medical image.

In 720, the task management module 420 may determine a requested volume of a VGPU resource corresponding to each of the at least one task.

The requested volume of the VGPU resource corresponding to each of the at least one task may be determined based on a volume of data relating to each of the at least one task. The data relating to the at least one task may include, for example, data to be processed, a processing algorithm, a processing model, etc. Merely for illustration, the data relating to the at least one task may include one or more images, a count of images to be processed, a size of each of the images, a processing algorithm corresponding to each of the images, etc. In some embodiments, memory and/or CPU resources needed for processing each of the at least one task may also be determined.

In 730, the task management module 420 may add the at least one task to the message queue, and mark each of the at least one task according to at least the requested volume of the VGPU resource.

After the requested volume of the VGPU resource corresponding to each of the at least one task is determined, the task management module 420 may add the at least one task to the message queue, and mark each of the at least one task according to at least the requested volume of the VGPU resource. In some embodiments, the task management module 420 may mark each of the at least one task with a tag of the corresponding requested volume of the VGPU resource. For instance, a first task having a requested volume of the VGPU resource of 4 GB may be marked with a tag of 4 GB, a second task having a requested volume of the VGPU resource of 2 GB may be marked with a tag of 2 GB, and a third task having a requested volume of the VGPU resource of 2 GB may be marked with a tag of 2 GB. In this way, when the target container is caused to retrieve a target task from the message queue, the target task marked with a corresponding requested volume of the VGPU resource may be identified from the at least one task more efficiently. In some embodiments, the task management module 420 may also mark each of the at least one task with a matching status tag. The matching status tag may indicate whether the task matches a target container successfully. For instance, a matching failure tag may indicate a failure of the matching between the task and a target container.

In some embodiments, each of the at least one task may have a priority level. The at least one task added to the message queue may be arranged in an order in the message queue according to the priority level of each of the at least one task. In some embodiments, a task having a higher priority level may be arranged closer to a top of the message queue. When the target container is caused to retrieve a target task from the message queue, the task management module 420 may identify the target task from the at least one task by analyzing each of the at least one task according to the order in which the at least one task is arranged in the message queue from the top to the bottom of the message queue.

It should be noted that the above description of the process 700 is provided for the purposes of illustration, not intended to limit the scope of the present disclosure. For persons having ordinary skills in the art, multiple variations and modifications may be reduced to practice in the light of the present disclosure. However, these variations and modifications fall in the scope of the present disclosure. For example, the requested volume of the VGPU resource corresponding to each of the at least one task may also be recorded as a smallest integer that is larger than or equal to the requested volume, in a unit of, e.g., gigabyte (GB), megabyte (MB), kilobyte (KB), of the VGPU resource corresponding to the task. The recorded requested volume of the VGPU resource corresponding to a task may also be referred as a recorded volume of the VGPU resource corresponding to the task. Merely for illustration, if a requested volume of the VGPU resource corresponding to a task is 1.7 GB, the recorded volume of the VGPU resource corresponding to the task may be 2 GB.

According to the embodiments set forth above in the process 700, after the image processing request including the at least one task sent by the terminal device is received, the requested volume of the VGPU resource corresponding to each of the at least one task may be determined. The at least one task may be added to the message queue, and each of the at least one task may be marked with the requested volume of the VGPU resource. In the message queue, the at least one task may be arranged according to the priority level of each of the at least one task. By storing the at least one task in the message queue, the problem of a high concurrency of the at least one task may be solved, and the efficiency for processing the at least one task may be improved, and the security of data relating to the at least one task may be enhanced.

FIG. 8 is a flowchart illustrating an exemplary process for causing a target container to obtain a target task from a message queue according to some embodiments of the present disclosure. In some embodiments, the process 800 may be executed by the imaging system 100. For example, the process 800 may be implemented as a set of instructions (e.g., an application) stored in a storage device (e.g., the storage device 130). The modules described in FIG. 4 may execute the set of instructions and may accordingly be directed to perform the process 800. The operations of the illustrated process presented below are intended to be illustrative. In some embodiments, the process 800 may be accomplished with one or more additional operations not described and/or without one or more of the operations discussed. Additionally, the order of the operations of process 800 illustrated in FIG. 8 and described below is not intended to be limiting.

In 810, the container management module 410 may determine whether a requested volume of the VGPU resource corresponding to a current task in the message queue matches a capacity of a target container.

In some embodiments, the target container may obtain a tag marking the requested volume of the VGPU resource corresponding to the current task, and determine the requested volume of the VGPU resource corresponding to the current task based on the tag. The container management module 410 may determine whether the requested volume of the VGPU resource corresponding to the current task matches the capacity of the target container. The capacity of the target container refers to a volume of the VGPU resource allocated to the target container.

In some embodiments, the container management module 410 may determine whether the requested volume of the VGPU resource corresponding to the current task is smaller than or equal to the capacity of the target container. If the requested volume of the VGPU resource corresponding to the current task is smaller than or equal to the capacity of the target container, the container management module 410 may determine that the requested volume of the VGPU resource corresponding to the current task matches the capacity of the target container, and the process 800 may proceed to 820. If the requested volume of the VGPU resource corresponding to the current task is larger than the capacity of the target container, the container management module 410 may determine that the requested volume of the VGPU resource corresponding to the current task does not match the capacity of the target container, and the process 800 may proceed to 830.

In 820, the container management module 410 may designate the current task as the target task.

If the requested volume of the VGPU resource corresponding to the current task matches the capacity of the target container, the current task may be designated as the target task for the target container. For example, the message queue may include a first task and a second task. A requested volume of the VGPU resource corresponding to the first task may be 3.94 GB, and a requested volume of the VGPU resource corresponding to the second task may be 1.82 GB. The capacity of the target container may be 4 GB. If the first task is the current task, the VGPU resource requested by the first task matches the capacity of the target container. The first task may be designated as the target task for the target container.

In 830, the container management module 410 may determine whether a requested volume of the VGPU resource corresponding to a subsequent task in the message queue matches the capacity of the target container.

If the requested volume of the VGPU resource corresponding to the current task does not match the capacity of the target container, the container management module 410 may further determine whether the subsequent task is the target task corresponding to the target container. As used herein, a subsequent task of a current task refers to a task immediately after the current task according to the order in which the at least one task is arranged in the message queue. The container management module 410 may further determine whether the subsequent task is the target task corresponding to the target container by determining whether the requested volume of the VGPU resource corresponding to the subsequent task matches the capacity of the target container. If the requested volume of the VGPU resource corresponding to the subsequent task matches the capacity of the target container, the subsequent task may be designated as the target task corresponding to the target container. If the requested volume of the VGPU resource corresponding to the subsequent task does not match the capacity of the target container, the container management module 410 may further determine whether a task immediately after the subsequent task is the target task corresponding to the target container. The operations 810 through 830 may be repeated in one or more cycles until the target task corresponding to the target container is determined.

For example, the message queue may include a third task and a fourth task. A requested volume of the VGPU resource corresponding to the third task may be 4 GB. The VGPU resource allocated to the target container may be 2 GB. If the third task is determined as the current task, the container management module 410 may determine whether the requested volume of the VGPU resource corresponding to the third task matches the capacity of the target container. Since the requested volume of the VGPU resource corresponding to the third task is larger than the capacity of the VGPU resource allocated to the target container, the container management module 410 may determine that the requested volume of the VGPU resource corresponding to the third task does not match the capacity of the target container. The fourth task may be determined as the subsequent task. The container management module 410 may determine whether the requested volume of the VGPU resource corresponding to the fourth task matches the capacity of the target container. A requested volume of the VGPU resource corresponding to the fourth task may be 2 GB. Since the requested volume of the VGPU resource corresponding to the fourth task is smaller than the capacity of the VGPU resource allocated to the target container, the container management module 410 may determine that the requested volume of the VGPU resource corresponding to the fourth task matches the capacity of the target container. The fourth task may be designated as the target task.

As for the target container, if all the tasks in the message queue do not match the capacity of the target container, the target container may be reset (e.g., replaced with a renewed target container allocated with the VGPU resource of a larger volume). In some embodiments, the target container may also be arranged to an end of a queue of the one or more target containers.

In some embodiments, as for a task, if the requested volume of the VGPU resource corresponding to the task does not match the capacity of the target container, the task may be marked with a match failure tag indicating the failure of the matching to the target container. The match failure tag may be obtained and considered by the container management module 410 each time one of the one or more target containers identifies a corresponding target task, thus avoiding invalid matching and saving computing resources. For example, as for a second target container having the VGPU resource of a volume smaller than or equal to that of a first target container, a task having a match failure tag indicating the failure of the matching to the first target container may be omitted when the second target container is caused to retrieve a corresponding target task.

In some embodiments, if the requested volume of the VGPU resource corresponding to a task does not match the capacity of any one of the plurality of containers, the task may not be processed, and feedback information regarding the task may be transmitted to the terminal device 140. In some embodiments, the task may be transmitted to another processing apparatus (e.g., an edge node, a cloud server, etc., as described in FIGS. 10-18) for processing.

In some embodiments, if the requested volume of the VGPU resource corresponding to the current task does not match the capacity of the target container, the container management module 410 may put the current task back into the message queue. In some embodiments, the current task may be put back to an original position of the current task in the message queue. For example, if the requested volume of the VGPU resource corresponding to the second task does not match the capacity of the target container, the second task may be put back to the message queue, and still arranged as the second task in the remaining of the message queue. In some embodiments, the current task may be arranged to a top or a bottom of the message queue.

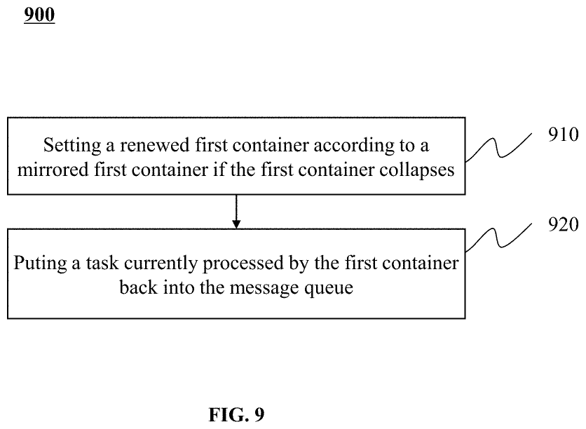

FIG. 9 is a flowchart illustrating an exemplary process for recovering a first container from a collapse according to some embodiments of the present disclosure. In some embodiments, the process 900 may be executed by the imaging system 100. For example, the process 900 may be implemented as a set of instructions (e.g., an application) stored in a storage device (e.g., the storage device 130). The modules described in FIG. 4 may execute the set of instructions and may accordingly be directed to perform the process 900. The operations of the illustrated process presented below are intended to be illustrative. In some embodiments, the process 900 may be accomplished with one or more additional operations not described and/or without one or more of the operations discussed. Additionally, the order of the operations of process 900 illustrated in FIG. 9 and described below is not intended to be limiting.

In 910, the container management module 410 may set a renewed first container according to a mirrored first container if the first container collapses.

The mirrored first container refers to a container that is the same as the first container. In some embodiments, a mirrored container of each of the plurality of containers may be pre-stored in the storage device (e.g., the storage device 130). If the first container collapses (e.g., a server on which the first container is implemented does not work, the VGPU resource allocated to the first container fails, etc.), the container management module 410 may set the mirrored first container as the renewed first container.

In 920, the container management module 410 may put a task currently processed by the first container back into the message queue.

When the first container collapses, the task currently processed by the first container may not be fulfilled. In this case, after the container management module 410 identifies that the first container collapses, the task currently being processed by the first container may be put back into the message queue (e.g., arranged at an original position of the task), so that the task may be processed by the renewed first container or another container. After the task is retrieved by a container for processing or processed by the container, the task may be removed from the message queue. By putting the task currently being processed by the first container back into the message queue, the at least one task in the message queue may be retained (not lost) due to a collapse of a container, which may improve the reliability of message queue.

FIG. 10 is a schematic diagram illustrating an exemplary processing apparatus according to some embodiments of the present disclosure.

The processing apparatus 120 may include a terminal device 1010, one or more edge nodes 1020, and a cloud server 1030. As shown in FIG. 10, the terminal device 1010, the one or more edge nodes 1020, and/or the cloud server 1030 may communicate with each other via wired connections and/or wireless connections. The wired connections may include an electrical cable, an optical cable, or the like, or any combination thereof. The wireless connections may include a Bluetooth network, a Wi-Fi network, a WiMax network, a WLAN, a mobile network (e.g., 3G, 4G, 5G), or the like, or any combination thereof. Merely by way of example, data (e.g., medical images, image processing requests including at least one task, etc.) and/or information (e.g., basic information of a patient) may be transmitted between different components (e.g., the terminal device 1010, the one or more edge nodes 1020, and/or the cloud server 1030) of the processing apparatus 120.

The terminal device 1010 may have a certain capacity for data processing. For instance, the terminal device 1010 may be a client terminal, a console, or the terminal device 140. An edge node 1020 may be a node implemented by a computing device (e.g., a server, a computer, etc.) in a computing network. In some embodiments, the one or more edge nodes 1020 may be set at one or more locations in a geographic region. For example, the one or more edge nodes 1020 may include a first edge node set at a hospital, a second edge node set at a university, and a third edge node set at a medical research center. The cloud server 1030 may be an independent server or a server cluster including a plurality of servers. The cloud server 1030 may include, for example, a private cloud, a public cloud, a hybrid cloud, a community cloud, a distributed cloud, an inter-cloud, a multi-cloud, or the like, or any combination thereof.

In some embodiments, a communication distance between the terminal device 1010 and the edge node 1020 may be shorter than a communication distance between the terminal device 1010 and the cloud server 1030. As used herein, the communication distance between a first device and a second device may be a parameter representing a real-time performance of the first device for processing a task from the second device. The communication distance may be a physical distance between the two devices or a virtual parameter regarding the first device and/or the second device. The virtual parameter may relate to, for example, a network delay time between the two devices, local area network (LAN) addresses of the first device and the second device, configuration parameters of the first device and/or the second device, a packet internet groper (PING) command, etc. For example, the communication distance between the terminal device 1010 and the edge node 1020 may be a distance between the terminal device 1010 and the edge node 1020. As another example, the communication distance between the terminal device 1010 and the edge node 1020 may be a network delay time between the terminal device 1010 and the edge node 1020.

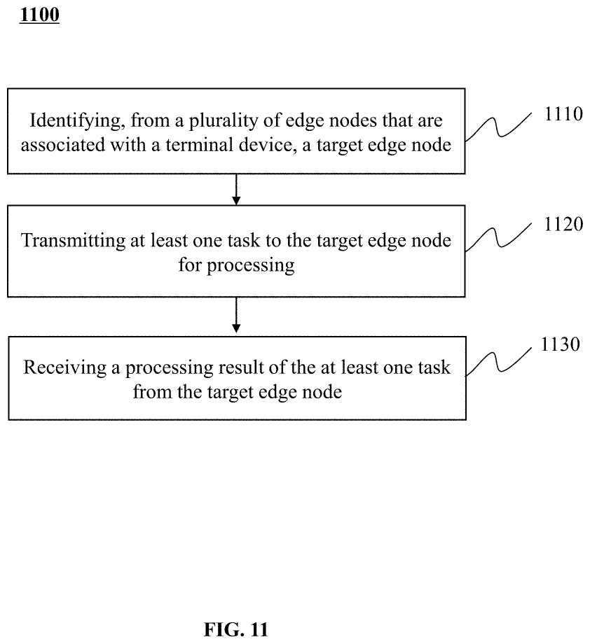

FIG. 11 is a flowchart illustrating an exemplary process for scheduling resources of a processing apparatus according to some embodiments of the present disclosure. In some embodiments, the process 1100 may be executed by the imaging system 100. For example, the process 1100 may be implemented as a set of instructions (e.g., an application) stored in a storage device (e.g., the storage device 130). The modules described in FIG. 4 may execute the set of instructions and may accordingly be directed to perform the process 1100. The operations of the illustrated process presented below are intended to be illustrative. In some embodiments, the process 1100 may be accomplished with one or more additional operations not described and/or without one or more of the operations discussed. Additionally, the order of the operations of process 1100 illustrated in FIG. 11 and described below is not intended to be limiting.

In 1110, the resource scheduling module 430 (e.g., the terminal device 1010) may identify, from a plurality of edge nodes that are associated with a terminal device, a target edge node.

The resource scheduling module 430 may determine a plurality of edge nodes 1020 that are associated with the terminal device (e.g., the terminal device 1010). In some embodiments, the plurality of edge nodes 1020 may be nodes implemented by, for example, servers, computers, etc., that are in communication with the terminal device 1010. In some embodiments, the plurality of edge nodes 1020 may be set at one or more locations in a geographic region. In order to improve a real-time performance of the plurality of edge nodes 1020, a communication distance between the terminal device 1010 and each of the plurality of edge nodes 1020 may be shorter than a communication distance between the terminal device 1010 and the cloud server 1030.

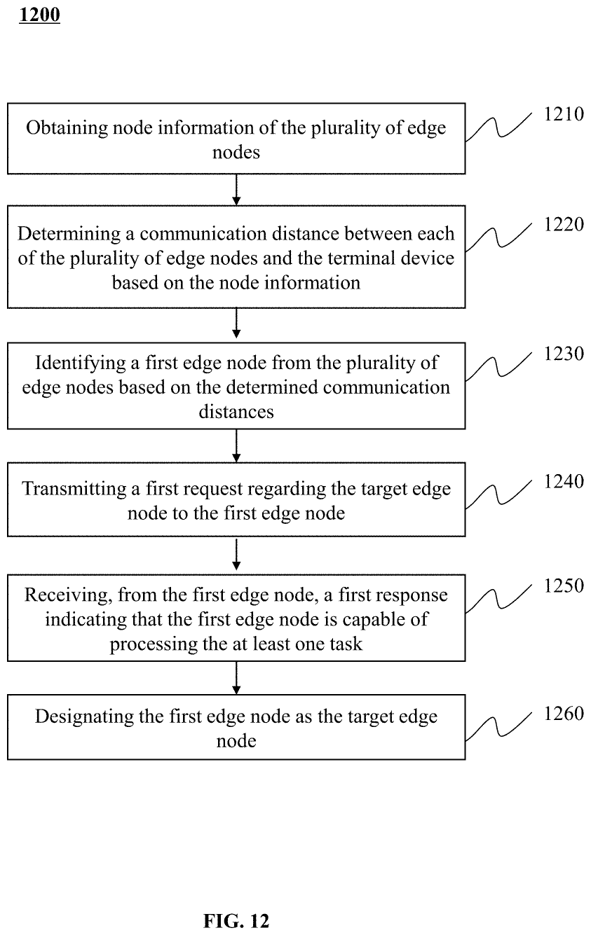

The target edge node may be identified from the plurality of edge nodes 1020 associated with the terminal device 1010 if resources (e.g., a GPU resource, a CPU resource, etc.) of the terminal device 1010 are insufficient for processing at least one task (e.g., image processing task). The target edge node may be used to process the at least one task. In some embodiments, the target edge node may be identified from the plurality of edge nodes 1020 based at least in part on a communication distance between the terminal device 1010 and the target edge node. For example, an edge node that corresponds to a shortest communication distance to the terminal device 1010 among communication distances between the terminal device 1010 and one or more edge nodes that are capable of processing the at least one task may be determined as the target edge node. In some embodiments, the communication distance between the terminal device 1010 and the target edge node may be within a certain range. The certain range may be determined by a user, according to default settings of the imaging system 100, etc. Details regarding the identification of the target edge node may be found elsewhere in the present disclosure. See, for example, FIGS. 12-14 and the descriptions thereof.

In 1120, the resource scheduling module 430 (e.g., the terminal device 1010) may transmit at least one task to the target edge node for processing.

In some embodiments, the resource scheduling module 430 may transmit data relating to the at least one task to the target edge node for processing. For example, if the at least one task includes a calculation task, the data relating to the at least one task may include calculation data (e.g., a calculation algorithm, one or more parameters, etc.). If the at least one task includes an image rendering task, the data relating to the at least one task may include image data. If the at least one task further includes other tasks, the data relating to the at least one task may include corresponding data received by the target edge node.

In some embodiments, after the target edge node is identified, the terminal device 1010 may transmit the data relating to the at least one task to the target edge node. The target edge node may perform corresponding operations to process the at least one task. For example, the terminal device 1010 may transmit data relating to a calculation task (e.g., calculation data) to the target edge node, so that the target edge node may schedule resources for calculation and perform one or more calculation operations on the calculation data based on the resources for calculation. As another example, the terminal device 1010 may transmit data relating to a rendering task (e.g., image data) to the target edge node, so that the target edge node may schedule resources for image rendering and perform an image rendering operation on the image data based on the resources for image rendering.

In some embodiments, different target edge nodes may be suitable for processing tasks of different types, such as data calculation tasks, image reconstruction tasks, image rendering tasks, model training tasks, or the like. Such an arrangement may improve the efficiency of data processing by avoiding the need to repeatedly transmit an algorithm and configure a target edge node for running the algorithm to perform different tasks of different types; instead, for different tasks of a same type, only data of the different tasks need to be transmitted from the terminal device 1010 to and being processed by the target edge node. Before the target edge node is identified, a type of each of the at least one task (also referred to as task type) may be determined. The target edge node may be identified according to the task type of the at least one task. In some embodiments, the target edge node may process the at least one task according to the task type of the at least one task.

In 1130, the resource scheduling module 430 (e.g., the terminal device 1010) may receive a processing result of the at least one task from the target edge node.

A processing result of the at least one task may be generated after the target edge node processes the at least one task. The terminal device 1010 may receive the processing result from the target edge node. For example, if the at least one task includes a calculation task, the target edge node may process the calculation task and generate a corresponding calculation result (e.g., a value). The terminal device 1010 may receive the calculation result from the target edge node, and output the calculation result, for example, via the I/O 230. As another example, if the at least one task includes an image rendering task, the target edge node may process the image rendering task and generate a corresponding image rendering result (e.g., a rendered image). The terminal device 1010 may receive the image rendering result from the target edge node, and display the image rendering result, for example, via the screen 160.

According to the embodiments set forth above in the process 1100, the target edge node may be identified from the plurality of edge nodes 1020 that are associated with the terminal device 1010. The at least one task may be transmitted to the target edge node for processing. The target edge node may perform corresponding operations to process the at least one task. Then the processing result of the at least one task may be received from the target edge node. When the local resources (e.g., a CPU resource, a GPU resource, a memory resource, etc.) of the terminal device 1010 are insufficient, an edge node that corresponds to a shortest communication distance to the terminal device 1010 among communication distances between the terminal device 1010 and one or more edge nodes that are capable of processing the at least one task may be determined as the target edge node. In addition, the communication distance between the terminal device 1010 and each of the plurality of edge nodes 1020 may be shorter than the communication distance between the terminal device 1010 and the cloud server 1030, and thus the demand for a communication bandwidth for the terminal device 1010 may be lowered. The at least one task may be processed by the target edge node, which facilitates an extension of the local resources of the terminal device 1010, and improves a real-time performance on the processing of the at least one task.

FIG. 12 is a flowchart illustrating an exemplary process for identifying a target edge node from a plurality of edge nodes according to some embodiments of the present disclosure. In some embodiments, the process 1200 may be executed by the imaging system 100. For example, the process 1200 may be implemented as a set of instructions (e.g., an application) stored in a storage device (e.g., the storage device 130). The modules described in FIG. 4 may execute the set of instructions and may accordingly be directed to perform the process 1200. The operations of the illustrated process presented below are intended to be illustrative. In some embodiments, the process 1200 may be accomplished with one or more additional operations not described and/or without one or more of the operations discussed. Additionally, the order of the operations of process 1200 illustrated in FIG. 12 and described below is not intended to be limiting.

In 1210, the resource scheduling module 430 (e.g., the terminal device 1010) may obtain node information of the plurality of edge nodes.

The node information may include, for example, a geographic location, an LAN address, a name, a volume of resources (e.g., a CPU resource, a memory resource, a VGPU resource, etc.), a network delay time, configuration parameters, etc., of each of the plurality of edge nodes 1020. In some embodiments, the node information may be obtained from the plurality of edge nodes 1020, the cloud server 1030, a storage device (e.g., the storage device 130), etc.

In 1220, the resource scheduling module 430 (e.g., the terminal device 1010) may determine a communication distance between each of the plurality of edge nodes and the terminal device based on the node information.

In some embodiments, a communication distance between each of the plurality of edge nodes 1020 and the terminal device 1010 may be a distance that a signal transmits between each of the plurality of edge nodes 1020 and the terminal device 1010 when the terminal device 1010 communicates with the plurality of edge nodes 1020. For instance, if a distance that a signal transmits between the terminal device 1010 and an edge node 1020 is 5.3 kilometers (km), the communication distance between the terminal device 1010 and an edge node 1020 may be determined as 5.3 km. In some embodiments, the communication distance may be simplified as a straight-line distance. As provided in the above example, the distance that the signal transmits between the terminal device 1010 and the edge node 1020 is 5.3 km. If a straight-line distance between the terminal device 1010 and the edge node 1020 is 4.5 km, the communication distance between the terminal device 1010 and an edge node 1020 may be determined as 4.5 km. In some embodiments, the communication distance may be a virtual parameter. The virtual parameter may relate to, for example, a network delay time, a local area network (LAN) address, configuration parameters, a packet internet groper (PING) command, etc. For instance, if a network delay time between the terminal device 1010 and an edge node 1020 is 100 milliseconds (ms), the communication distance between the terminal device 1010 and the edge node 1020 may be determined as 100 ms. A communication distance between the terminal device 1010 and an edge node may affect a bandwidth of the terminal device 1010 and/or the edge node 1020 required for a task transmitted to the edge node 1020 from the terminal device 1010. In order to improve the real-time performance on the processing of the at least one task received from the terminal device 1010, the communication distance between each of the plurality of edge nodes 1020 and the terminal device 1010 may be determined based on the node information.

In 1230, the resource scheduling module 430 (e.g., the terminal device 1010) may identify a first edge node from the plurality of edge nodes based on the determined communication distances.

The first edge node may be an edge node having a better real-time performance on the processing of the at least one task from the terminal device than those of other edge nodes. In some embodiments, the first edge node may be an edge node having a shortest communication distance to the terminal device 1010 among the plurality of edge nodes 1020. The communication distance between the first edge node and the terminal device 1010 may also be referred to as first communication distance. In some embodiments, the resource scheduling module 430 may identify a shortest communication distance from the determined communication distances between the terminal device 1010 and the plurality of edge nodes 1020. An edge node that corresponds to the shortest communication distance may be determined as the first edge node.

In 1240, the resource scheduling module 430 (e.g., the terminal device 1010) may transmit a first request regarding the target edge node to the first edge node.

In some embodiments, the first request regarding the target edge node may include data relating to the at least one task and a first request message regarding the target edge node. Merely by way of example, the data relating to the at least one task may include one or more images, a count of the one or more images to be processed, a size of each of the one or more images, a processing algorithm corresponding to each of the one or more images, etc. The first request message regarding the target edge node may be a message for verifying whether the first edge node is capable of processing the at least one task. In some other embodiments, the first request may not include at least a portion of the data relating to the at least one task (e.g., the image data), which may occupy limited resources. The limited resources may be used to verify whether the first edge node is capable of processing the at least one task, thus saving resources of the first edge node and improving the efficiency on identifying the target edge node.

In some embodiments, a first determination as to whether resources (e.g., a GPU resource, a CPU resource, etc.) of the first edge node are sufficient for processing the at least one task and a second determination as to whether the first edge node is idle (e.g., unoccupied) may be made. If the resources of the first edge node are sufficient for the at least one task (e.g., a requested volume of each resource of the at least one task is smaller than or equal to a volume of the corresponding resource of the first edge node), and the first edge node is idle, the resource scheduling module 430 may determine that the first edge node is capable of processing the at least one task.

In 1250, the resource scheduling module 430 (e.g., the terminal device 1010) may receive, from the first edge node, a first response indicating that the first edge node is capable of processing the at least one task.

If the first edge node is capable of processing the at least one task, the first edge node may transmit the first response to the terminal device 1010. The first response from the first edge node may indicate that the first edge node is capable of processing the at least one task.

In 1260, the resource scheduling module 430 (e.g., the terminal device 1010) may designate the first edge node as the target edge node.

After the terminal device 1010 receives the first response indicating that the first edge node is capable of processing the at least one task, the first edge node may be designated as the target edge node, and terminal device 1010 may transmit the at least one task to the target edge node for processing.

In some embodiments, if the first edge node is incapable of processing the at least one task, the first edge node may not transmit the first response to the terminal device 1010. Instead, the first edge node may transmit a second request to a cloud server (e.g., the cloud server 1030). The second request may indicate that the first edge node is incapable of processing the at least one task.

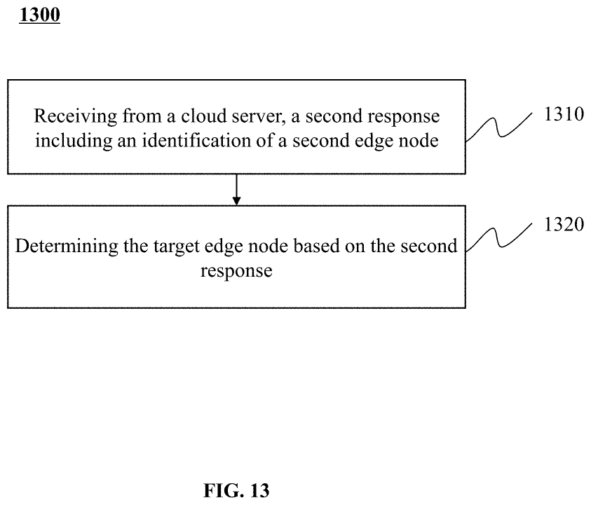

FIG. 13 is a flowchart illustrating an exemplary process for identifying a target edge node from a plurality of edge nodes according to some embodiments of the present disclosure. In some embodiments, the process 1300 may be executed by the imaging system 100. For example, the process 1300 may be implemented as a set of instructions (e.g., an application) stored in a storage device (e.g., the storage device 130). The modules described in FIG. 4 may execute the set of instructions and may accordingly be directed to perform the process 1300. The operations of the illustrated process presented below are intended to be illustrative. In some embodiments, the process 1300 may be accomplished with one or more additional operations not described and/or without one or more of the operations discussed. Additionally, the order of the operations of process 1300 illustrated in FIG. 13 and described below is not intended to be limiting.

In 1310, the resource scheduling module 430 (e.g., the terminal device 1010) may receive from a cloud server, a second response including an identification of a second edge node.

In combination with the process 1200 as illustrated in FIG. 12, after the cloud server 1030 receives the second request indicating that the first edge node is incapable of processing the at least one task, the cloud server 1030 may allocate a second edge node for processing the at least one task. The second edge node may be an edge node having the shortest distance to the terminal device 1010 among edge nodes that are capable of processing the at least one task.

The first communication distance between the first edge node and the terminal device 1010 may be shorter than a second communication distance between the second edge node and the terminal device 1010. The cloud server 1030 may generate the second response. The second response may include the identification of the second edge node. The resource scheduling module 430 may identify the second edge node based on the identification of the second edge node.

In 1320, the resource scheduling module 430 (e.g., the terminal device 1010) may determine the target edge node based on the second response.

After the terminal device 1010 receives the second response including the identification of the second edge node, the second edge node may be identified based on the second response. The second edge node may be designated as the target edge node, and terminal device 1010 may transmit the at least one task to the target edge node for processing. In this way, the resource scheduling module 430 (e.g., the terminal device 1010) may not need to transmit a request to the second edge node to determine whether the second edge node is capable of processing the at least one task, thus improving the efficiency for identifying the target edge node from the plurality of edge nodes.

According to the embodiments set forth in the process 1300, if the resources of the first edge node are insufficient for processing the at least one task and/or the first edge node is occupied, the second edge node may be allocated, by the cloud server 1030, to process the at least one task received from the terminal device 1010. In this case, a request (e.g., the first request) from the terminal device 1010 may be processed in time, which improves a response efficiency of the request from the terminal device 1010.

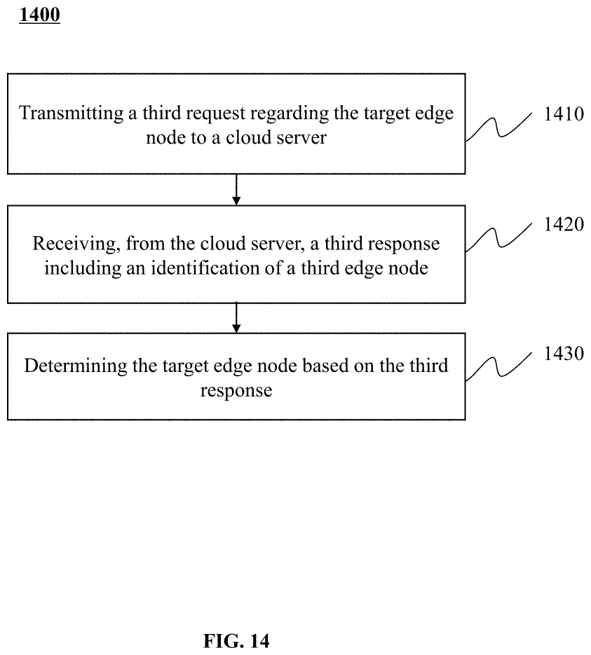

FIG. 14 is a flowchart illustrating an exemplary process for identifying a target edge node from a plurality of edge nodes according to some embodiments of the present disclosure. In some embodiments, the process 1400 may be executed by the imaging system 100. For example, the process 1400 may be implemented as a set of instructions (e.g., an application) stored in a storage device (e.g., the storage device 130). The modules described in FIG. 4 may execute the set of instructions and may accordingly be directed to perform the process 1400. The operations of the illustrated process presented below are intended to be illustrative. In some embodiments, the process 1400 may be accomplished with one or more additional operations not described and/or without one or more of the operations discussed. Additionally, the order of the operations of process 1400 illustrated in FIG. 14 and described below is not intended to be limiting.

In 1410, the resource scheduling module 430 (e.g., the terminal device 1010) may transmit a third request regarding the target edge node to a cloud server.

In some embodiments, the third request regarding the target edge node may include the data relating to the at least one task and a third request message regarding the target edge node. Merely by way of example, the data relating to the at least one task may include one or more images, a count of the one or more images to be processed, a size of each of the one or more images, a processing algorithm corresponding to each of the one or more images, etc. The third request message regarding the target edge node may be a message for identifying the target edge node from a plurality of edge nodes (e.g., the edge nodes 1020). The target edge node may be identified based on at least a portion of the data relating to the at least one task. In some other embodiments, the third request may not include at least a portion of the data relating to the at least one task (e.g., the image data), which may occupy limited resources. The limited resources may be used to identify the target edge node that is capable of processing the at least one task, thus saving resources of the cloud server 1030 and improving the efficiency for identifying the target edge node.

In some embodiments, the terminal device 1010 may transmit the third request to the cloud server 1030 directly when the resources of the terminal device 1010 are insufficient, such that the cloud server 1030 may identify, from the plurality of edge nodes 1020, the target edge node according to the third request.

In 1420, the resource scheduling module 430 (e.g., the terminal device 1010) may receive, from the cloud server, a third response including an identification of a third edge node.

After the cloud server 1030 receives the third request, the cloud server 1030 may identify, from the plurality of edge nodes 1020, the target edge node according to the third request. In some embodiments, the cloud server 1030 may identify a third edge node that is capable of processing the at least one task (e.g., resources (e.g., a GPU resource, a CPU resource, etc.) of the third edge node are sufficient for the at least one task and the third edge node is idle (e.g., unoccupied)). The third edge node may correspond to a shortest communication distance among communication distances between edge nodes allocated by the cloud server 1030 (i.e., edge nodes that are capable of processing the at least one task among the plurality of edge nodes 1020) and the terminal device 1010.

The cloud server 1030 may generate third response including an identification of the third edge node. The cloud server 1030 may transmit the third response to the terminal device 1010. The resource scheduling module 430 may identify the third edge node based on the identification of the third edge node.

In 1430, the resource scheduling module 430 (e.g., the terminal device 1010) may determine the target edge node based on the third response.

After the terminal device 1010 receives the third response indicating that the third edge node is capable of processing the at least one task, the third edge node may be designated as the target edge node, and terminal device 1010 may transmit the at least one task to the target edge node for processing.

According to the embodiments set forth in the process 1400, the target edge node capable of processing the at least one task may be determined by the cloud server 1030 directly. The cloud server 1030 may obtain communication distances between the terminal device 1010 and the plurality of edge nodes and a capacity and/or an occupation status of each of the plurality of edge nodes. The cloud server 1030 may identify, from the plurality of edge nodes 1020, the target node based on the communication distances and the capacity and/or occupation status of each of the plurality of edge nodes. The identification of the target edge node by the cloud server 1030 directly may improve the efficiency for identifying the target edge node.

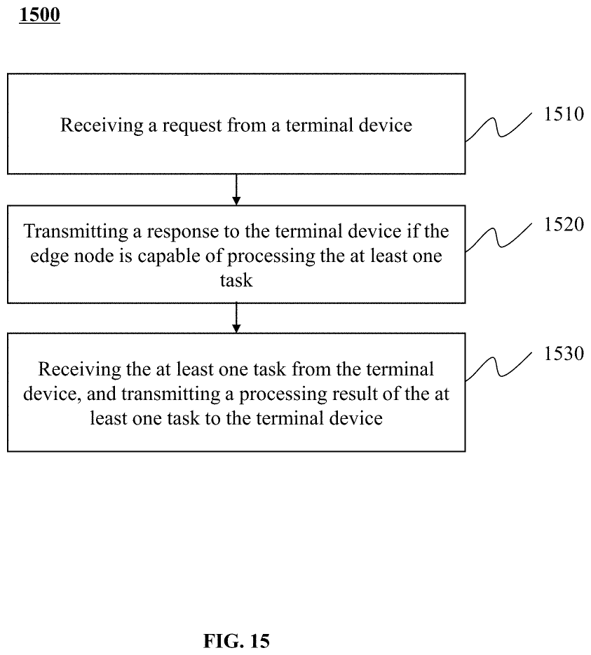

FIG. 15 is a flowchart illustrating an exemplary process for identifying a target edge node according to some embodiments of the present disclosure. In some embodiments, the process 1500 may be executed by the imaging system 100. For example, the process 1500 may be implemented as a set of instructions (e.g., an application) stored in a storage device (e.g., the storage device 130). The modules described in FIG. 4 may execute the set of instructions and may accordingly be directed to perform the process 1500. The operations of the illustrated process presented below are intended to be illustrative. In some embodiments, the process 1500 may be accomplished with one or more additional operations not described and/or without one or more of the operations discussed. Additionally, the order of the operations of process 1500 illustrated in FIG. 15 and described below is not intended to be limiting.

In 1510, the resource scheduling module 430 (e.g., a first edge node) may receive a request from a terminal device.

The request (e.g., the first request as described in the process 1200) may include a request message for verifying whether the first edge node is capable of processing the at least one task. When resources of the terminal device 1010 are insufficient for processing at least one task, the terminal device 1010 may transmit the request to the first edge node to determine the target edge node for processing the at least one task. The first edge node may receive the request from the terminal device 1010. A first determination as to whether resources of the first edge node are sufficient for processing the at least one task and a second determination as to whether the first edge node is idle may be made. In some embodiments, in order to improve a real-time performance for processing the at least one task, a communication distance between the terminal device 1010 and the first edge node may be shorter than the communication distance between the terminal device 1010 and the cloud server 1030.

In 1520, the resource scheduling module 430 (e.g., the first edge node) may transmit a response to the terminal device if the edge node is capable of processing the at least one task.

If the resources of the first edge node are sufficient for processing the at least one task and the first edge node is idle, it may be determined that the first edge node is capable of processing the at least one task from the terminal device 1010, and the first edge node may be determined as a target edge node. The first edge node may transmit the response (e.g., the first response as described in the process 1200) to the terminal device 1010. The response may instruct the terminal device 1010 to transmit the at least one task to the first edge node for processing.

In some embodiments, the request may further include a task type of each of the at least one task (e.g., a data calculation task, an image reconstruction task, an image rendering task, a model training task, etc.). The determination as to whether the first edge node is capable of processing the at least one task may be made according to the task type of each of the at least one task. For example, if the at least one task includes a calculation task, a determination as to whether the edge node is capable of processing the calculation task may be made. As another example, if the at least one task includes an image rendering task, a determination as to whether the edge node is capable of processing the image rendering task may be made.

In 1530, the resource scheduling module 430 (e.g., the first edge node) may receive the at least one task from the terminal device, and transmit a processing result of the at least one task to the terminal device.

In some embodiments, the first edge node may receive the data relating to the at least one task. For example, if the at least one task includes a calculation task, the data relating to the at least one task may include calculation data (e.g., a calculation algorithm, one or more parameters, etc.). If the at least one task includes an image rendering task, the data relating to the at least one task may include image data. If the at least one task further includes other tasks, the data relating to the at least one task may include corresponding data received by the target edge node.

The first edge node may be designated as the target edge node. The target edge node may perform corresponding operations to process the at least one task. For example, as for a calculation task, the target edge node may schedule resources for calculation and perform one or more calculation operations on calculation data based on the resources for calculation. As another example, as for a rendering task, the target edge node may schedule resources for image rendering and perform an image rendering operation on image data based on the resources for image rendering.

According to the embodiments set forth above in the process 1500, the first edge node may receive the request from the terminal device 1010, transmit the response to the terminal device 1010 if the edge node is capable of processing the at least one task, receive the at least one task from the terminal device 1010, process the task by performing the corresponding operations, and transmit the processing result to the terminal device 1010. When the local resources of the terminal device 1010 are insufficient, the first edge node may obtain the request from the terminal device 1010. If the first edge node is capable of processing the at least one task, the first edge node may transmit the response to the terminal device 1010, receive the at least one task from the terminal device 1010, and process the at least one task. The communication distance between the first edge node and the terminal device 1010 may be shorter than the communication distance between the terminal device 1010 and the cloud server 1030. In this way, the requirement of communication bandwidth may be lowered. The at least one task may be processed by the first edge node, which facilitates an extension of the local resources of the terminal device 1010, and improves a real-time performance on the processing of the at least one task.

In some embodiments, when the first edge node is incapable of processing the at least one task (e.g., the resources of the first edge node are occupied), the first edge node may transmit a request (e.g., the second request as described in the process 1300) to the cloud server 1030. The request transmitted to the cloud server 1030 may indicate that the first edge node is incapable of processing the at least one task, and the cloud server 1030 is needed to allocate a second edge node for processing the at least one task. The second edge node may be an edge node having the shortest distance to the terminal device 1010 among edge nodes that are capable of processing the at least one task. In this case, the request from the terminal device 1010 may be processed in time, which improves a response efficiency of the request.

The second edge node may be designated as the target edge node. The target edge node may perform corresponding operations to process the at least one task and transmit a processing result of the at least one task to the terminal device 1010. For example, as for a calculation task, the target edge node may schedule resources for calculation and perform one or more calculation operations on calculation data based on the resources for calculation. The target edge node may transmit a calculation result of the calculation task to the terminal device 1010. As another example, as for a rendering task, the target edge node may schedule resources for image rendering and perform an image rendering operation on image data based on the resources for image rendering. The target edge node may transmit an image rendering result of the image rendering task to the terminal device 1010. The target edge node may release the resources for image rendering after an instruction indicating that the image rendering task is complete is received from the terminal device 1010.

In some embodiments, after the target edge node receives the at least one task, the second edge node may determine the task type of each of the at least one task according to the data relating to the at least one task. If a current task is a calculation task, the target edge node may perform a calculation operation to process the calculation task using a calculation service directly. The target edge node may transmit a calculation result of the calculation task to the terminal device 1010. If the current task is an image rendering task, the target edge node may schedule resources for image rendering and perform an image rendering operation on image data based on the resources for image rendering. The target edge node may transmit an image rendering result of the image rendering task to the terminal device 1010 after the image rendering task is complete. In this case, the processing of the at least one task may be fulfilled successfully and the processing efficiency of the at least one task from the terminal device 1010 may be improved.

In some embodiments, the resources for calculation in the target edge node (e.g., the first edge node or the second edge node) may be resident, which may not be reallocated or released. The image rendering may need to be scheduled and loaded in real time. After an image rendering task is complete, the corresponding resources for image rendering may be released. Therefore, after the image rendering task from the terminal device 1010 is complete, the target edge node may receive an instruction for terminating the image rendering process from the terminal device 1010, terminate the image rendering process according to the instruction, and release the resources for image rendering. In some embodiments, the instruction for terminating the image rendering process may include a triggered request input via an interface of the terminal device 1010. Exemplary triggered requests may include a “complete” quest, a “save” request, or the like. In some embodiments, when the target edge node does not receive data relating to the rendering task for a period of time, the target edge node may terminate the image rendering process.

Generally, data relating to the image rendering task may be image data, which consumes a relatively large volume of resources. The target edge node may process the image rendering task in parallel with the terminal device 1010 even if the terminal device 1010 does not transmit the image rendering task to the target edge node, thus avoiding the problem that the target edge node may need to obtain the data relating to the image rendering task to complete the rendering task, which consumes excessive resources of the target edge node, due to the lack of the resources of the terminal device 1010 during the image rendering process. In some cases, for example, in an application scenario with a bandwidth of 5 GB, the bandwidth may be sufficient for the processing of the image rendering task at any time. In such a case, the target edge nodes may not process the image rendering task in parallel with the terminal device 1010.

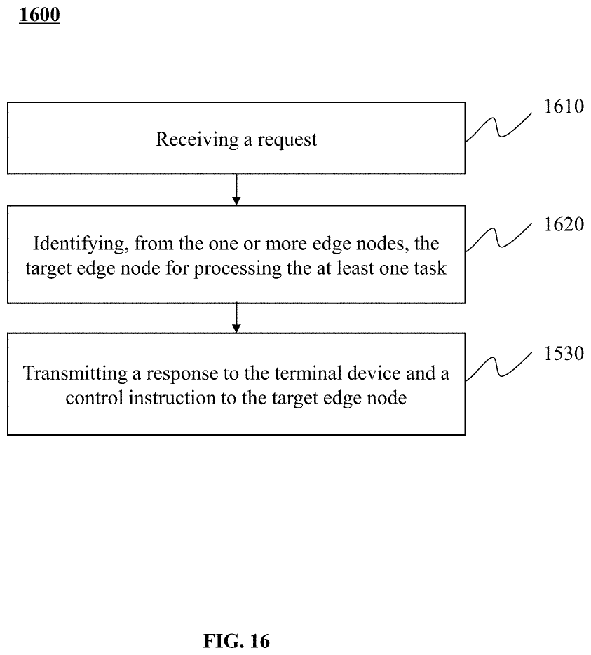

FIG. 16 is a flowchart illustrating an exemplary process for scheduling resources of the processing apparatus for processing at least one task from a terminal device according to some embodiments of the present disclosure. In some embodiments, the process 1600 may be executed by the imaging system 100. For example, the process 1600 may be implemented as a set of instructions (e.g., an application) stored in a storage device (e.g., the storage device 130). The modules described in FIG. 4 may execute the set of instructions and may accordingly be directed to perform the process 1600. The operations of the illustrated process presented below are intended to be illustrative. In some embodiments, the process 1600 may be accomplished with one or more additional operations not described and/or without one or more of the operations discussed. Additionally, the order of the operations of process 1600 illustrated in FIG. 16 and described below is not intended to be limiting.

In 1610, the resource scheduling module 430 (e.g., the cloud server 1030) may receive a request (e.g., the second request as described in the process 1300 or the third request as described in the process 1400).

In some embodiments, the cloud server 1030 may receive the request from the terminal device 1010 or an edge node 1020. In some embodiments, the request may include an identification of the terminal device 1010. The cloud server 1030 may identify the terminal device 1010 based on the identification of the terminal device 1010. In some embodiments, the cloud server 1030 may identify one or more edge nodes that are capable of processing the at least one task. A communication distance between the terminal device 1010 and each of the one or more edge nodes may be shorter than a communication distance between the terminal device 1010 and the cloud server 1030.

In 1620, the resource scheduling module 430 (e.g., the cloud server 1030) may identify, from the one or more edge nodes, the target edge node for processing the at least one task.

The target edge node may be identified from the one or more edge nodes that are capable of processing the at least one task. In some embodiments, the target edge node may correspond to a shortest communication distance among communication distances between the terminal device 1010 and the one or more edge nodes.

Merely for illustration, after the cloud server 1030 receives the request, the cloud server 1030 may determine an LAN address of the terminal device 1010 based on the identification of the terminal device 1010. Also, an LAN address of each of the one or more edge nodes may be obtained. Communication distances between the terminal device 1010 and the one or more edge nodes may be determined based on the LAN address of the terminal device 1010 and the LAN address of each of the one or more edge nodes. An edge node corresponding to a shortest communication distance among the communication distances between the terminal device 1010 and the one or more edge nodes may be identified and designated as the target edge node.

In some embodiments, the cloud server 1030 may also set a threshold distance for the terminal device 1010. The cloud server 1030 may determine at least one edge node that is within the distance threshold. An edge node that is capable of processing the at least one task and has the shortest distance to the terminal device 1010 among the communication distance between the terminal device 1010 and the at least one edge node may be designated as the target edge node.

In 1630, the resource scheduling module 430 (e.g., the cloud server 1030) may transmit a response to the terminal device and a control instruction to the target edge node.

The response (e.g., the second response as described in the process 1300 or the third response as described in the process 1400) may instruct the terminal device 1010 to transmit the at least one task to the target edge node, and the control instruction may instruct the target edge node to process the at least one task by performing corresponding operations, and transmit a processing result to the terminal device 1010.

In some embodiments, the response may include an identification of the target edge node (e.g., the second edge node or the third edge node). After the target edge node is determined, the cloud server 1030 may transmit the response including the identification of the target edge node to the terminal device 1010. The target edge node may be identified based on the identification of the target edge node. The terminal device 1010 may transmit the at least one task to the target edge node. At the same time, the cloud server may also transmit the control instruction to the target edge node to instruct the target edge node to process the at least one task by performing corresponding operations.

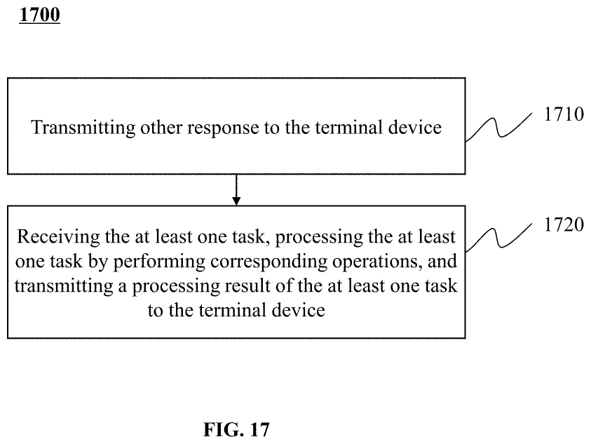

FIG. 17 is a flowchart illustrating an exemplary process for scheduling resources of the processing apparatus to process at least one task from a terminal device according to some embodiments of the present disclosure. In some embodiments, the process 1700 may be executed by the imaging system 100. For example, the process 1700 may be implemented as a set of instructions (e.g., an application) stored in a storage device (e.g., the storage device 130). The modules described in FIG. 4 may execute the set of instructions and may accordingly be directed to perform the process 1700. The operations of the illustrated process presented below are intended to be illustrative. In some embodiments, the process 1700 may be accomplished with one or more additional operations not described and/or without one or more of the operations discussed. Additionally, the order of the operations of process 1700 illustrated in FIG. 17 and described below is not intended to be limiting. In some embodiments, the process 1700 may be described in connection with the process 1600 as illustrated in FIG. 16. Operations in the process 1700 may be performed if there is no target edge node identified from the plurality of edge nodes. For example, none of the plurality of edge nodes 1020 may be capable of processing the at least one task from the terminal device 1010.

In 1710, the resource scheduling module 430 (e.g., the cloud server 1030) may transmit other response to the terminal device.

The other response may also be referred to as a fourth response so as to distinguish the other response from the first response, the second response, and the third response. The fourth response may instruct the terminal device 1010 to transmit the at least one task to the cloud server 1030 directly.

In some embodiments, if there is no edge node capable of processing the at least one task, the cloud server 1030 may transmit the fourth response to the terminal device 1010. The fourth response may instruct the terminal device 1010 to transmit the at least one task to the cloud server 1030 for processing.

In 1720, the resource scheduling module 430 (e.g., the cloud server 1030) may receive the at least one task, process the at least one task by performing corresponding operations, and transmit a processing result of the at least one task to the terminal device.

The cloud server 1030 may process the at least one task by performing one or more operations. The operations may be determined according to the data relating to the at least one task and/or a task type of each of the at least one task. For example, if the at least one task received by the cloud server 1030 includes a calculation task, the cloud server 1030 may schedule resources for calculation and process the calculation task by performing a calculation operation using the resources for calculation. After the calculation task is complete, the cloud server 1030 may transmit a calculation result to the terminal device 1010. If the at least one task received by the cloud server 1030 includes an image rendering task, the cloud server 1030 may schedule resources for image rendering and process the image rendering task by performing an image rendering operation using the resources for image rendering. After the image rendering task is complete, the cloud server 1030 may transmit an image rendering result to the terminal device 1010.

According to the embodiments set forth in the process 1700, in the case that there is no target edge node, the cloud server 1030 may receive and process the at least one task from the terminal device 1010, such that the request from the terminal device may be processed in time, which improves a response efficiency of the request from the terminal device 1010.

In some embodiments, the cloud server 1030 may select a processing approach for a task based on a task type of the task. The cloud server 1030 may process the task according to the processing approach. In some embodiments, the processing approach may include at least one of scheduling resources to perform corresponding operations, allocating and scheduling resources to perform corresponding operations, or postponing the processing of the at least one task. In some embodiments, the processing approach may be selected by a user after the task type of each of the at least one task is provided to the user.

In some embodiments, a correspondence relationship between task types and processing approaches may be established. The cloud server 1030 may select a processing approach for processing a task according to the correspondence relationship and a task type of the task. In some embodiments, the correspondence relationship between the task types and the processing approaches may be obtained by training a primary relationship between task types and the processing approaches using a machine learning method. In some embodiments, the cloud server 1030 may determine a corresponding processing approach for processing each of the at least one task based on the correspondence relationship, which improves the processing efficiency of the target edge node.

In some embodiments, the correspondence relationship between the task types and the processing approaches may be obtained by receiving a manual setting from a user, analyzing historical records, and analyzing configurations of the target edge node. To analyze historical records, historical performances such as resource occupancies, processing speeds, transmission durations and/or other data or information may be obtained by filtering and sorting the historical records or a machine learning process. The correspondence relationship between the task types and the processing approaches may be obtained based on the historical performances of the target edge node.

In some embodiments, different target edge nodes may be suitable for processing tasks of different task types (e.g., image reconstruction tasks, data calculation tasks, image rendering tasks, model training tasks, etc.). In some embodiments, after the cloud server 1030 receives a task, a task type of the task may be determined. A list of candidate target edge nodes may be determined according to the task type of task, and a target edge node may be selected from the list of the candidate target edge nodes. The target edge node may perform corresponding operations to process the at least one task. In this case, the target edge node suitable for processing tasks of a specific task type may be determined based on the task type of a task. The target edge node may process the task more efficiently.

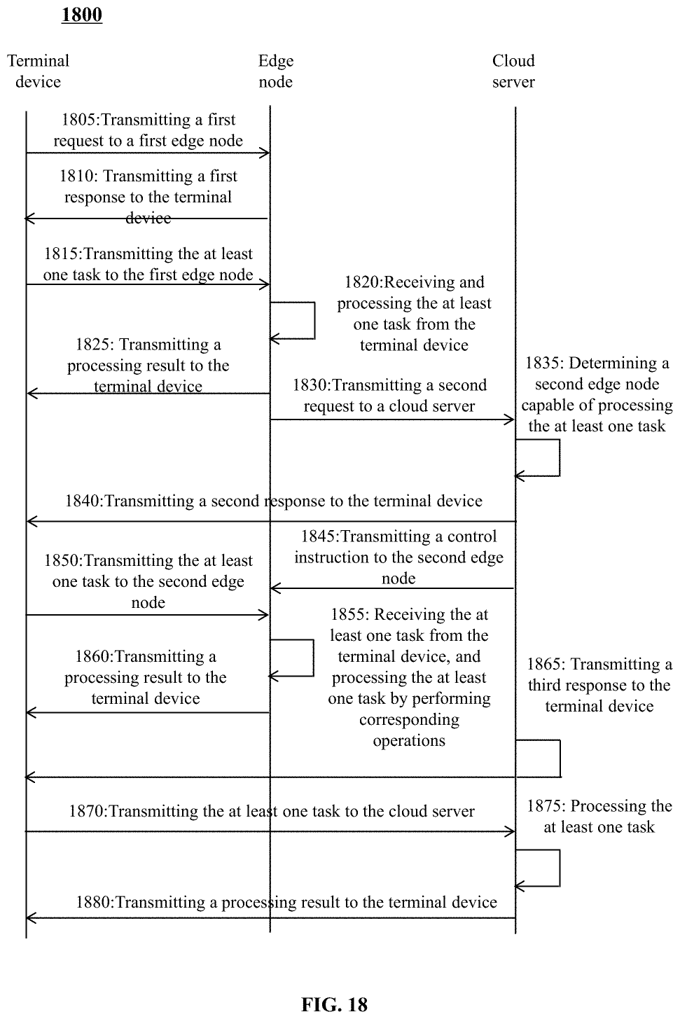

FIG. 18 is a flowchart illustrating an exemplary process for scheduling resources of the processing apparatus to process at least one task from a terminal device according to some embodiments of the present disclosure. In some embodiments, the process 1800 may be executed by the imaging system 100. For example, the process 1800 may be implemented as a set of instructions (e.g., an application) stored in a storage device (e.g., the storage device 130). The modules described in FIG. 4 may execute the set of instructions and may accordingly be directed to perform the process 1800. The operations of the illustrated process presented below are intended to be illustrative. In some embodiments, the process 1800 may be accomplished with one or more additional operations not described and/or without one or more of the operations discussed. Additionally, the order of the operations of process 1800 illustrated in FIG. 18 and described below is not intended to be limiting.

In 1805, the resource scheduling module 430 (e.g., the terminal device 1010) may transmit a first request to a first edge node having a shortest communication distance to the terminal device.

In 1810, the resource scheduling module 430 (e.g., the first edge node) may transmit a first response to the terminal device if the edge node is capable of executing at least one task from the terminal device.

In 1815, the resource scheduling module 430 (e.g., the terminal device 1010) may transmit the at least one task to the first edge node.

In 1820, the resource scheduling module 430 (e.g., the first edge node) may receive the at least one task from the terminal device, and process the at least one task by performing corresponding operations.

In 1825, the resource scheduling module 430 (e.g., the first edge node) may transmit a processing result to the terminal device.

In 1830, the resource scheduling module 430 (e.g., the first edge node) may transmit a second request to a cloud server if the first edge node is incapable of processing the task.

In 1835, the resource scheduling module 430 (e.g., the cloud server 1030) may determine a second edge node capable of processing the at least one task according to an identification of the terminal device.

In 1840, the resource scheduling module 430 (e.g., the cloud server 1030) may transmit a second response to the terminal device.

In 1845, the resource scheduling module 430 (e.g., the cloud server 1030) may transmit a control instruction to the second edge node.

In 1850, the resource scheduling module 430 (e.g., the terminal device 1010) may transmit the at least one task to the second edge node.

In 1855, the resource scheduling module 430 (e.g., the second edge node) may receive the at least one task from the terminal device, and process the at least one task by performing corresponding operations.

In 1860, the resource scheduling module 430 (e.g., the second edge node) may transmit a processing result to the terminal device.

In 1865, the resource scheduling module 430 (e.g., the cloud server 1030) may transmit a third response to the terminal device if the cloud server determines that there is no edge node capable of processing the at least one task.

In 1870, the resource scheduling module 430 (e.g., the terminal device 1010) may transmit the at least one task to the cloud server.

In 1875, the resource scheduling module 430 (e.g., the cloud server 1030) may process the at least one task by performing corresponding operations.

In 1880, the resource scheduling module 430 (e.g., the cloud server 1030) may transmit a processing result to the terminal device.

An entire process for scheduling resources of edge computing and cloud computing for processing at least one task when resources of a terminal device are insufficient for the at least one task may be provided in the process 1800. In some embodiments, the operations 1805 through 1880 may be similar to or the same as the operations in the processes 1100-1700 as illustrated in FIGS. 11-17, and are not repeated here.

In some embodiments, after the target edge node is determined or it is determined that there is no target edge node, the at least one task may be transmitted to the target edge node or the cloud server 1030 for processing. In some embodiments, the at least one task may include an image processing task. In some embodiments, a plurality of containers may be set on a processing apparatus. A VGPU resource may be allocated to each of the plurality of containers. Each of the plurality of containers may occupy a corresponding VGPU resource. In some embodiments, a VGPU resource corresponding to a container may have a specific volume, such as 1 GB, 2 GB, 4 GB, 8 GB, etc. In some embodiments, one or more target containers may be identified from the plurality of containers. The target containers may be in the idle states. For each of the one or more target containers, the target container may be caused to retrieve and process a target task from the at least one task. In some embodiments, the at least one task may be added into a message queue, in which the at least one task may be ranked in an order according to, for example, a priority level of each of the at least one task. Details regarding the processing of the at least one task using the one or more target container are described in the processes 600 through 1000 as illustrated in FIGS. 6-10, and are not repeated here.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method, comprising:
setting a plurality of containers on a processing apparatus, each of the plurality of containers is allocated with a corresponding virtual graphic processing unit (VGPU) resource;
identifying one or more target containers from the plurality of containers;
for each of the one or more target containers,
causing the target container to obtain a target task from a message queue that includes at least one task; and
causing the target container to process the target task.

2. The method of claim 1, wherein the processing apparatus includes at least one cloud server cluster.

3. The method of claim 1, further including:
receiving a processing request from a terminal device, the processing request including at least one task;
for each of the at least one task, determining a requested volume of a VGPU resource corresponding to the task;
adding the at least one task to the message queue; and
marking each of the at least one task according to at least the requested volume of the VGPU resource.

4. The method of claim 3, wherein the causing the target container to obtain a target task from a message queue that includes at least one task includes:
identifying the target task from the message queue based at least in part on the requested volume of the VGPU resource corresponding to the target task.

5. The method of claim 4, wherein the identifying the target task from the message queue based at least in part on the requested volume of the VGPU resource corresponding to the target task including:
determining whether a requested volume of the VGPU resource corresponding to a current task in the message queue matches a capacity of the target container; and
in response to determining that the requested volume of the VGPU resource corresponding to the current task matches the capacity of the target container,
designating the current task as the target task.

6. The method of claim 5, further including:
in response to determining that the requested volume of the VGPU resource corresponding to the current task does not match the capacity of the target container,
putting the current task back into the message queue; and
determining whether a requested volume of the VGPU resource corresponding to a subsequent task in the message queue matches the capacity of the target container.

7. The method of claim 6, wherein each of the at least one task has a priority level, the at least one task being arranged in an order in the message queue according to the priority level of each of the at least one task.

8. The method of claim 1, wherein each of the plurality of containers corresponds to a VGPU resource.

9. The method of claim 1, wherein a capacity of a first container of the plurality of containers is different from a capacity of a second container of the plurality of containers.

10. The method of claim 1, further including:
setting a renewed first container according to a mirrored first container if a first container collapses; and
putting a task processed by the first container back into the message queue.

11. A method, comprising:
identifying, from a plurality of edge nodes that are associated with a terminal device, a target edge node;
transmitting at least one task to the target edge node for processing; and
receiving a processing result of the at least one task from the target edge node.

12. The method of claim 11, wherein the identifying, from a plurality of edge nodes that are associated with a terminal device, a target edge node includes:
obtaining node information of the plurality of edge nodes;
determining a communication distance between each of at least a portion of the plurality of edge nodes and the terminal device based on the node information;
identifying a first edge node from the plurality of edge nodes based on the determined communication distances; and
transmitting a first request regarding the target edge node to the first edge node.

13. The method of claim 12, further including:
receiving, from the first edge node, a first response indicating that the first edge node is capable of processing the at least one task; and
designating the first edge node as the target edge node.

14. The method of claim 12, further including:
receiving, from a cloud server, a second response including an identification of a second edge node, the second edge node being allocated by the cloud server in response to the second request indicating that the first edge node is incapable of processing the at least one task, and a first communication distance between the first edge node and the terminal device being shorter than a second communication distance between the second edge node and the terminal device; and
determining the target edge node based on the second response.

15. The method of claim 11, wherein the identifying, from a plurality of edge nodes that are associated with a terminal device, a target edge node includes:
transmitting a third request regarding the target edge node to a cloud server;
receiving, from the cloud server, a third response including an identification of a third edge node, the third edge node being capable of processing the at least one task, and the third edge node corresponding to a shortest communication distance among communication distances between edge nodes allocated by the cloud server and the terminal device; and
determining the target edge node based on the third response.

16. The method of claim 11, wherein the target edge node includes one or more target containers, the one or more target containers corresponding to virtual graphic processing unit (VGPU) resources.

17. The method of claim 16, further including:
causing the one or more target containers to obtain and process the at least one task.

18. The method of claim 11, further including:
transmitting the at least one task to a cloud server for processing if there is no target edge node; and
receiving a processing result of the at least one task from the cloud server.

19. The method of claim 18, wherein the cloud server includes one or more target containers, the one or more target containers corresponding to VGPU resources.

20. A system, comprising:
a processing apparatus configured to perform operations including:
setting a plurality of containers on the processing apparatus, each of the plurality of containers is allocated with a corresponding virtual graphic processing unit (VGPU) resource;
identifying one or more target containers from the plurality of containers;
for each of the one or more target containers,
causing the target container to obtain a target task from a message queue that includes at least one task; and
causing the target container to process the target task.
